(19) United States
(12) Patent Application Publication
(10) Pub. No.: US 2022/0371341 A1
(43) Pub. Date: Nov. 24, 2022

(54) PRINTER

(71) Applicant: FUJIFILM Corporation, Tokyo (JP)

(72) Inventor: Jun YAMANOBE, Kanagawa (JP)

(73) Assignee: FUJIFILM Corporation, Tokyo (JP)

(21) Appl. No.: 17/742,149

(22) Filed: May 11, 2022

(30) Foreign Application Priority Data
May 18, 2021 (JP) 2021-083765

(51) Int. Cl. B41J 11/42

(52) U.S. Cl. CPC B41J 11/42

(57) ABSTRACT

Provided is a printer capable of efficiently printing an image on a cylindrical recording medium with simple control.

A plurality of printing start positions are set on an outer circumferential surface of a recording medium. A processor performs transport control of the recording medium for a transport unit and printing control of the recording medium for a printing unit provided in each station. In the transport control, control for the transport unit is performed such that the recording medium is rotated at a constant speed, movement of the recording medium is stopped each time the recording medium arrives at the station, and the movement of the recording medium is restarted after printing at the station is completed. In the printing control, control for the printing unit of each station is performed such that image printing is started from the printing start position that first reaches the printing position.

### CROSS-REFERENCE TO RELATED APPLICATION

The present application claims priority under 35 U.S.C § 119(a) to Japanese Patent Application No. 2021-083765 filed on May 18, 2021, which is hereby expressly incorporated by reference, in its entirety, into the present application.

### BACKGROUND OF THE INVENTION

### 1. Field of the Invention

The present invention relates to a printer, and particularly to a printer that prints an image on an outer circumferential surface of a cylindrical recording medium.

### 2. Description of the Related Art

There is a printer that prints an image on an outer circumferential surface of a cylindrical recording medium.

JP2020-179674A discloses a printer that prints an image on the outer circumferential surface of a cylindrical recording medium according to an ink jet method. In the printer disclosed in JP2020-179674A, the recording medium is transported while being rotated in a circumferential direction, and images of a plurality of colors are printed on the outer circumferential surface of the recording medium by a plurality of ink jet heads provided on a transport path. At the time of printing, the movement of the recording medium is stopped at an installation position of each ink jet head while the recording medium is rotated.

### SUMMARY OF THE INVENTION

In the printer described in JP2020-179674A, the recording medium is rotated at a predetermined rotation speed and transported such that printing can be started without waiting time at the installation position of each ink jet head. Specifically, the recording medium is transported by determining a rotation speed such that the recording medium is rotated at an integer rotation speed and transported between the respective ink jet heads.

However, the printer disclosed in JP2020-179674A has a problem that a rotation speed of the recording medium that can be set is restricted by a layout of the ink jet heads and the like. As a result, there is a drawback that high speed printing with a high rotation speed, high quality printing with a low rotation speed, and the like cannot be performed.

A method of changing a rotation speed of a recording medium between transport and printing is conceivable, but has a drawback that acceleration and deceleration occur in the rotation and the control of transport becomes complicated.

The present invention has been made in view of such circumstances, and an object of the present invention is to provide a printer capable of efficiently printing an image on a cylindrical recording medium with simple control.

(1) According to an aspect of the present invention, there is provided a printer that prints an image on an outer circumferential surface of a cylindrical recording medium, the printer including a transport unit that transports the recording medium along a path while rotating the recording medium in a circumferential direction; a printing unit that is provided at each of a plurality of stations set on the path and prints an image on the outer circumferential surface of the recording medium located at a printing position; and a processor, in which a plurality of printing start positions are set on the outer circumferential surface of the recording medium, and the processor performs transport control of the recording medium for the transport unit, printing control of the recording medium for the printing unit provided in each station, in the transport control, performs control for the transport unit such that the recording medium is rotated at a constant speed, movement of the recording medium is stopped each time the recording medium arrives at the station, and the movement of the recording medium is restarted after printing at the station is completed, and in the printing control, performs control for the printing unit of each station such that image printing is started from the printing start position that first reaches the printing position.

(2) The printer of (1) further includes a selection unit that selects a rotation speed of the recording medium, in which the plurality of printing start positions are set on the outer circumferential surface of the recording medium for each rotation speed selectable by the selection unit, and the processor rotates the recording medium at the rotation speed selected by the selection unit in the transport control.

(3) In the printer of (2), a different number of printing start positions are set on the outer circumferential surface of the recording medium for each rotation speed selectable by the selection unit.

(4) In the printer of any one of (1) to (3), in a case where a time from when the recording medium arrives at the station to when the image printing is started is set as a waiting time, the printing start position is set to a position where the image printing is started for the preset waiting time at least at second and subsequent stations.

(5) In the printer of (4), at least at the second and subsequent stations, the printing start position is set to the position where the image printing is started for the same waiting time.

(6) In the printer of (4), at least at the second and subsequent stations, the printing start position is set to the position where the image printing is started for the waiting time of 0.

(7) In the printer of any one of (1) to (6), the stations are set at constant intervals on the path.

(8) According to another aspect of the present invention, there is provided a printer that prints an image on an outer circumferential surface of a cylindrical recording medium, the printer including a transport unit that transports the recording medium along a path while rotating the recording medium in a circumferential direction; a printing unit that is provided at each of a plurality of stations set on the path and prints an image on the outer circumferential surface of the recording medium located at a printing position, and a processor, in which a plurality of printing start positions are set on the outer circumferential surface of the recording medium, and the processor performs transport control of the recording medium for the transport unit, printing control of the recording medium for the printing unit provided in each station, in the printing control, performs control for the printing unit of each station such that image printing is started from a printing start position set on the outer circumferential surface of the recording medium, and in a case where a total number of the stations is denoted by n, i is 1, 2, . . . , and n, the plurality of stations are a first station, a second station, . . . , and an n-th station in order from an upstream side in a transport direction of the recording medium, a printing time at each station is denoted by U, a transport time of the recording medium transported between the stations is denoted by S, and a value obtained by discarding fractions below a decimal point in S/U is defined as <S/U>, the printing start position at an i-station is set to a position at a proportion of (i−1)×(S/U−<S/U>) with respect to an entire circumference of the substrate on the outer circumferential surface of the recording medium with a position where a front end of the image is printed on the outer circumferential surface of the recording medium as a reference.

(9) According to still another aspect of the present invention, there is provided a printer that prints an image on an outer circumferential surface of a cylindrical recording medium, the printer including a transport unit that transports the recording medium along a path while rotating the recording medium in a circumferential direction; a printing unit that is provided at each of a plurality of stations set at constant intervals on the path and prints an image on the outer circumferential surface of the recording medium located at a printing position, and a processor, in which a plurality of printing start positions are set on the outer circumferential surface of the recording medium, and the processor performs transport control of the recording medium for the transport unit, printing control of the recording medium for the printing unit provided in each station, in the printing control, performs control for the printing unit of each station such that image printing is started from a printing start position set on the outer circumferential surface of the recording medium, and in a case where a total number of the stations is denoted by n, i is 1, 2, . . . , and n, the plurality of stations are a first station, a second station, . . . , and an n-th station in order from an upstream side in a transport direction of the recording medium, a time for one rotation of the recording medium is denoted by T, a transport time of the recording medium transported from an i-th station to an (i+1)-th station is denoted by Si, and a printing time at the i-th station is denoted by Ui, a value obtained by discarding fractions below a decimal point in F(i) is defined as <F(i)> as follows, on the outer circumferential surface of the recording medium, with a position where a front end of the image is printed on the outer circumferential surface of the recording medium as a reference, the printing start position at the first station is set to a position at a proportion of 0 with respect to an entire circumference of the substrate, and the printing start position at the i-station after the second station is set to a position at a proportion of F(i)−<F(i)> with respect to the entire circumference of the substrate.

$$F ( i ) = \frac{{\sum }_{{j = 1}^{}}^{i - 1} ( Uj + Sj )}{T}$$

(10) In the printer of any one of (1) to (9), the printing unit prints the image according to an ink jet method.

According to the present invention, an image can be efficiently printed on a cylindrical recording medium with simple control.

### BRIEF DESCRIPTION OF THE DRAWINGS

FIG. 1 is a front view showing a schematic configuration of a printer.

FIG. 2 is a side view of the printer shown in FIG. 1.

FIG. 3 is a plan view of the printer shown in FIG. 1.

FIG. 4 is a diagram showing an example of disposition of ink jet heads at a station.

FIG. 5 is a block diagram showing an example of a hardware configuration of a control unit.

FIG. 6 is a block diagram showing main functions realized by the control unit.

FIG. 7 is a diagram showing an example of setting a printing start position.

FIG. 8 is a developed view of a substrate on which an image is printed.

FIGS. 9A to 9D are diagrams showing a flow of a printing process at a first station.

FIGS. 10A to 10D are diagrams showing a flow of a process of transporting a substrate from the first station to a second station.

FIGS. 11A to 11C are diagrams showing a flow of a printing process at the second station.

FIGS. 12A to 12D are diagrams showing a flow of a process of transporting the substrate from the second station to a third station.

FIGS. 13A to 13C are diagrams showing a flow of a printing process at the third station.

FIGS. 14A to 14D are diagrams showing a flow of a process of transporting the substrate from the third station to a fourth station.

FIGS. 15A to 15C are diagrams showing a flow of a printing process at the fourth station.

FIG. 16 is a table in which a difference in processing efficiency between a control method of the related art and a control method of the present embodiment is compared.

FIGS. 17A to 17D are diagrams showing an example of an image printed on an outer circumferential surface of the substrate at each station.

FIGS. 18A to 18D are conceptual diagrams of printing data of an image printed on the outer circumferential surface of the substrate at each station.

FIG. 19 is a diagram showing another example of setting a printing start position.

FIG. 20 is a table showing a flow and elapsed time of a series of printing processes in a case where printing start positions are set to three locations.

FIG. 21 is a developed view of the substrate on which an image is printed.

FIG. 22 is a table showing a flow and elapsed time of a series of printing processes.

FIG. 23 is a block diagram showing main functions realized by the control unit.

FIG. 24 is a table showing a flow and elapsed time of a series of printing processes in a case where a high speed mode is selected.

FIG. 25 is a table showing a flow and elapsed time of a series of printing processes in a case where a low speed mode is selected.

FIG. 26 is a block diagram showing main functions realized by the control unit in a case where a printing start position is set according to a selected rotation speed.

FIG. 27 is a table showing a flow and elapsed time of a series of printing processes in a case where the low speed mode is selected.

FIG. 28 is a table showing a flow and elapsed time of a series of printing processes in a case where an image is printed at each station without waiting time.

### DESCRIPTION OF THE PREFERRED EMBODIMENTS

Hereinafter, preferred embodiments of the present invention will be described in detail with reference to the accompanying drawings.

### First Embodiment

Here, a case where the present invention is applied to a printer that prints a color image on an outer circumferential surface of a cylindrical substrate such as a can according to an ink jet method will be described as an example. The substrate is an example of a recording medium.

Configuration

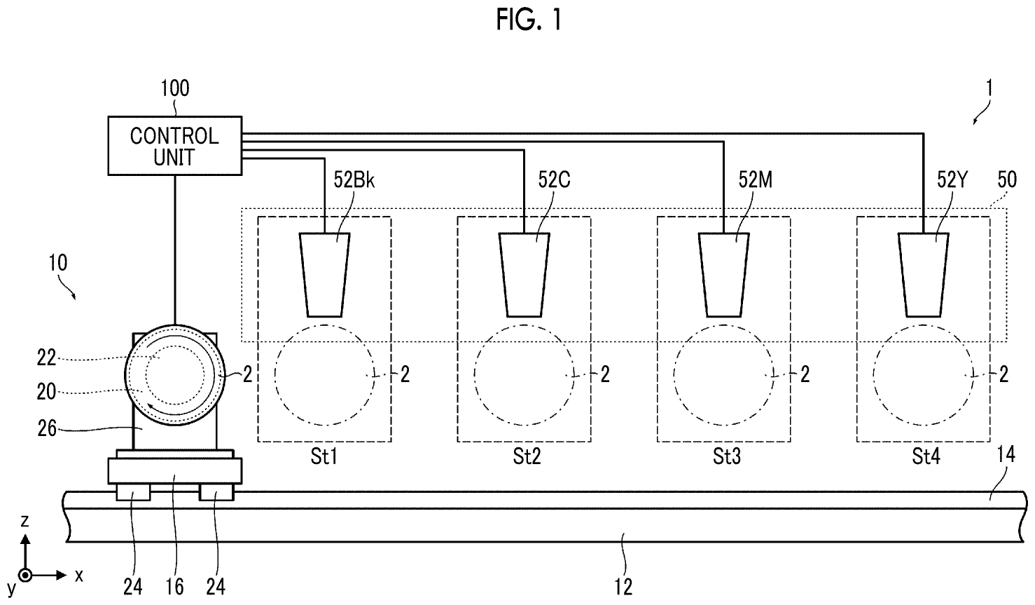

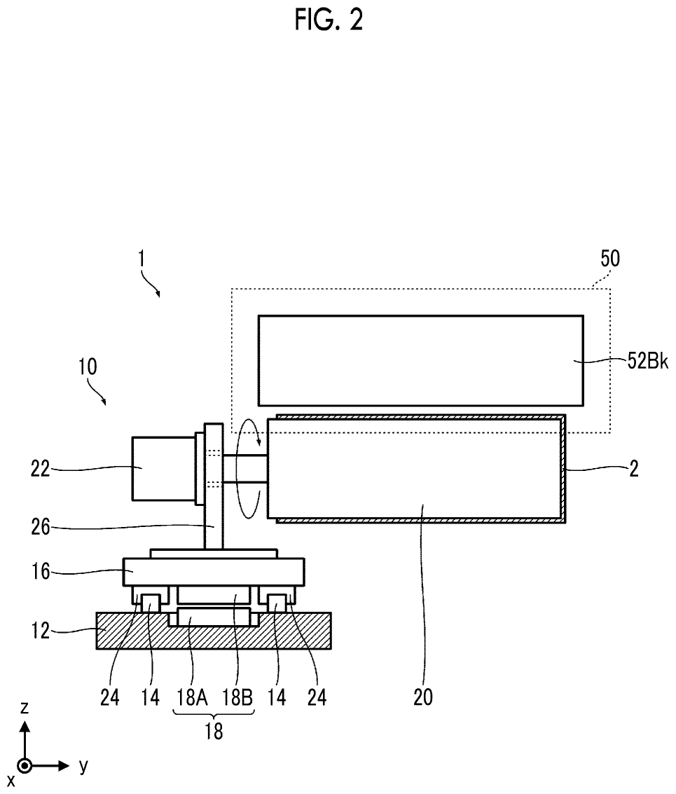

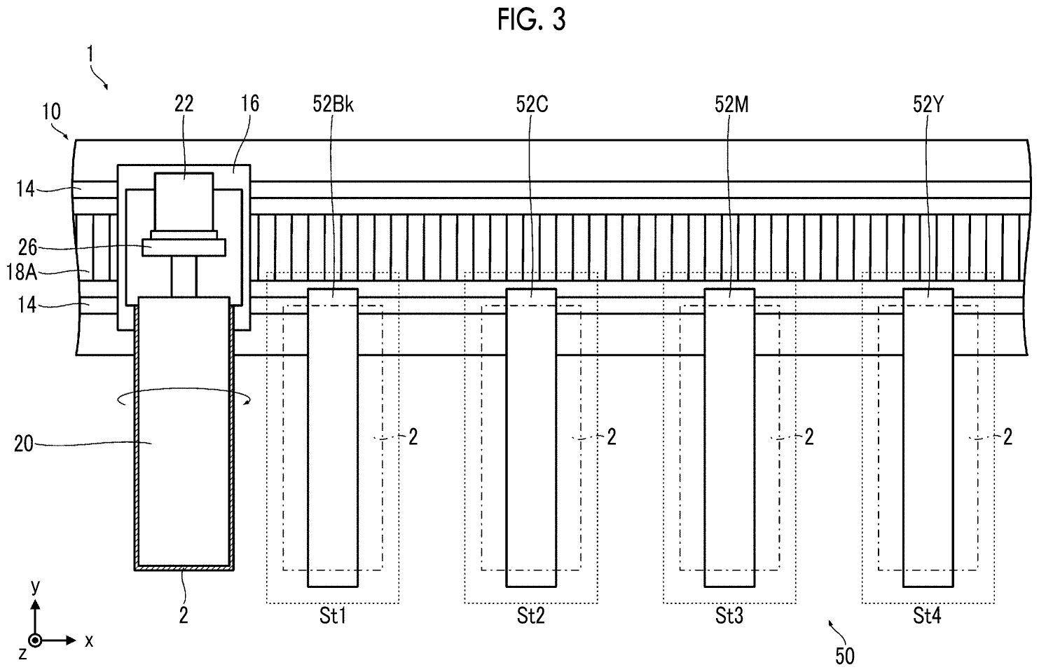

FIG. 1 is a front view showing a schematic configuration of a printer. FIG. 2 is a side view of the printer shown in FIG. 1. FIG. 3 is a plan view of the printer shown in FIG. 1.

As shown in the figures, a printer 1 of the present embodiment controls a transport unit 10 that transports a substrate 2, a printing unit 50 that prints an image on an outer circumferential surface of the substrate 2, and a control unit 100 that controls the printer 1.

Transport Unit

The transport unit 10 transports the substrate 2 along a predetermined path while being rotated the substrate 2 in a circumferential direction. The transport unit 10 includes a base 12, guide rails 14 laid on the base 12, a table 16 traveling on the guide rail 14, a table motor 18 that drives the table 16, a mandrel 20 provided on the table 16, and a mandrel motor 22 that drives the mandrel 20.

A pair of guide rails 14 is provided, and is laid along the transport path of the substrate 2. In the present embodiment, the substrate 2 is horizontally transported along a straight line. Therefore, the guide rails 14 are linearly configured and are laid horizontally.

A direction in which the guide rails 14 are laid in the horizontal plane (the transport direction of the substrate 2) is an x-axis direction. A direction orthogonal to the x axis in the horizontal plane is a y-axis direction. A direction orthogonal to the horizontal plane (x-y plane) is a z-axis direction.

The table 16 has a rectangular flat plate shape and is slidably supported on the guide rails 14 via guide blocks 24.

The table motor 18 drives the table 16 and causes the table 16 to travel along the guide rails 14. The table motor 18 is configured with a linear motor. The table 16 is provided with a coil unit 18A configuring the linear motor. The base 12 is provided with a magnet base 18B configuring the linear motor.

The mandrel 20 is holding means for holding the substrate 2, and is inserted into an inner circumferential portion of the substrate 2 to hold the substrate 2. In the present embodiment, the substrate 2 has a cylindrical shape with one end open and the other end closed. The substrate 2 is held by the mandrel 20 by inserting the mandrel 20 from the open end portion. The mandrel 20 is disposed horizontally and orthogonal to the transport direction (x-axis direction) of the substrate 2. That is, the mandrel 20 is disposed parallel to the y axis. Therefore, the substrate 2 held by the mandrel 20 is also held horizontally and is disposed orthogonal to the transport direction thereof. Specifically, an axis of the substrate 2 is disposed parallel to the y axis.

The mandrel motor 22 drives the mandrel 20 and rotates the mandrel 20 about an axis. The mandrel motor 22 is mounted on the table 16. Specifically, the mandrel motor 22 is attached to a bracket 26 provided on the table 16 and mounted on the table 16. An output shaft of the mandrel motor 22 mounted on the table 16 is disposed horizontally and orthogonal to the transport direction of the substrate 2. That is, the mandrel motor 22 is disposed parallel to the y axis. The mandrel 20 is mounted coaxially with the output shaft of the mandrel motor 22. Consequently, the mandrel 20 is disposed at a predetermined position on the table 16 in a predetermined posture. That is, the mandrel 20 is disposed horizontally at a position at a predetermined height from the table 16 and is disposed orthogonal to the transport direction of the substrate 2.

In the transport unit 10 configured as described above, in a case where the mandrel motor 22 is driven, the mandrel 20 is rotated about the axis. Consequently, the substrate 2 held by the mandrel 20 is rotated in the circumferential direction. In a case where the table motor 18 is driven, the table 16 is moved along the guide rails 14. Consequently, the substrate 2 is moved horizontally in the direction orthogonal to the rotation axis thereof.

The substrate 2 before printing is supplied at a supply station (not shown) set on the transport path and mounted on the mandrel 20. The substrate 2 after printing is detached from the mandrel 20 and collected at a collecting station (not shown) set on the transport path.

The transport unit 10 is an example of transport means.

Printing Unit

The printing unit 50 sequentially prints images on the outer circumferential surface of the substrate 2 at a plurality of stations set on the transport path of the substrate 2. In the printer 1 of the present embodiment, four stations St1, St2, St3, and St4 are set on the transport path of the substrate 2. Hereinafter, the four stations St1 to St4 will be distinguished by being referred to as a first station with the reference sign St1, a second station with the reference sign St2, a third station with the reference sign St3, and a fourth station with the reference sign St4. In the printer 1 of the present embodiment, the four stations St1 to St4 are set at regular intervals on the transport path of the substrate 2. Therefore, a movement distance of the substrate 2 between the stations is the same. Each station is located between the supply station and the collecting station.

Images of different colors are printed at the respective stations St1 to St4. In the printer 1 of the present embodiment, a black (Bk) image is printed at the first station St1. A cyan (C) image is printed at the second station St2. A magenta (M) image is printed at the third station St3. A yellow (Y) image is printed at the fourth station St4.

At each of the stations St1 to St4, the image is printed according to an ink jet method. The first station St1 is provided with an ink jet head 52Bk that ejects black ink droplets and prints a black image. The second station St2 is provided with an ink jet head 52C that ejects cyan ink droplets and prints a cyan image. The third station St3 is provided with an ink jet head 52M that ejects magenta ink droplets and prints a magenta image. The fourth station St4 is provided with an ink jet head 52Y that ejects yellow ink droplets and prints a yellow image.

The ink jet heads 52Bk, 52C, 52M, and 52Y are configured with line heads, and print an image on the outer circumferential surface of the substrate 2 that is being rotated in a single pass at the respective stations St1 to St4. Since an image is printed in a single pass, each of the ink jet heads 52Bk, 52C, 52M, and 52Y is configured to have a printing width longer than at least a width (a length in the axial direction) of the substrate 2. Disposition of nozzles is not particularly limited. Matrix-like disposition may also be employed.

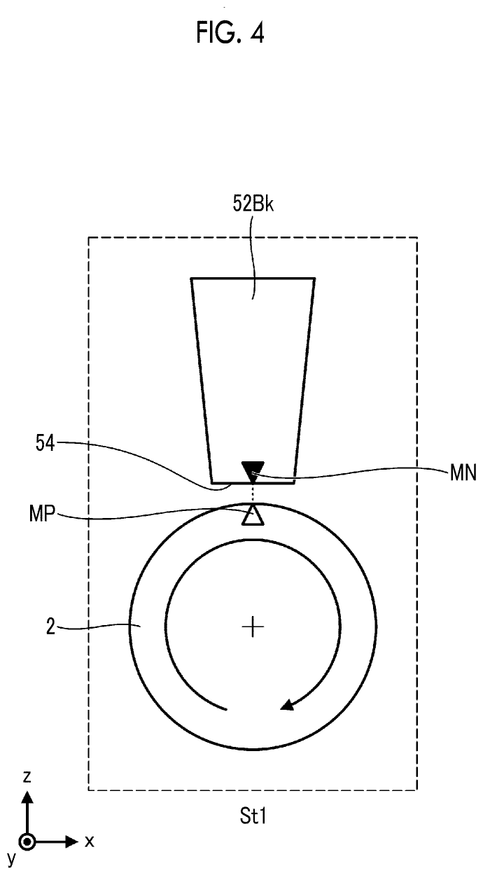

FIG. 4 is a diagram showing an example of disposition of the ink jet head at the station. Although FIG. 4 shows an example of disposition of the ink jet head 52Bk at the first station St1, the disposition at the other stations is the same.

The substrate 2 transported while being rotated by the transport unit 10 stops movement while being rotated at a predetermined stop position at each of the stations St1 to St4. In FIG. 1, a state in which the substrate 2 is stopped at the stop positions at the respectively stations St1 to St4 is shown by a dashed line.

The ink jet heads 52Bk, 52C, 52M, and 52Y each are disposed such that a nozzle surface 54 is located with a predetermined clearance directly above the substrate 2 located at the stop position at the stations St1 to St4. The nozzle surface 54 is a surface on which a nozzle is disposed.

In FIG. 4, a triangular mark MN indicates a position of the nozzle. A triangular mark MP indicates a position where ink droplets ejected from the nozzle are dropped on the substrate located at the stop position. As shown in FIG. 4, each of the ink jet heads 52Bk, 52C, 52M, and 52Y ejects ink droplets vertically downward toward the outer circumferential surface of the substrate 2 located at the stop position. A position where the ink droplets ejected from the ink jet heads 52Bk, 52C, 52M, and 52Y are dropped is a printing position. Therefore, the position indicated by the mark MP is a printing position. The outer circumferential surface of the substrate 2 sequentially passes through the printing position due to rotation, and thus an image is printed on the outer circumferential surface.

The ink jet heads 52Bk, 52C, 52M, and 52Y provided in the stations Sit to St4 are examples of printing means.

Control Unit

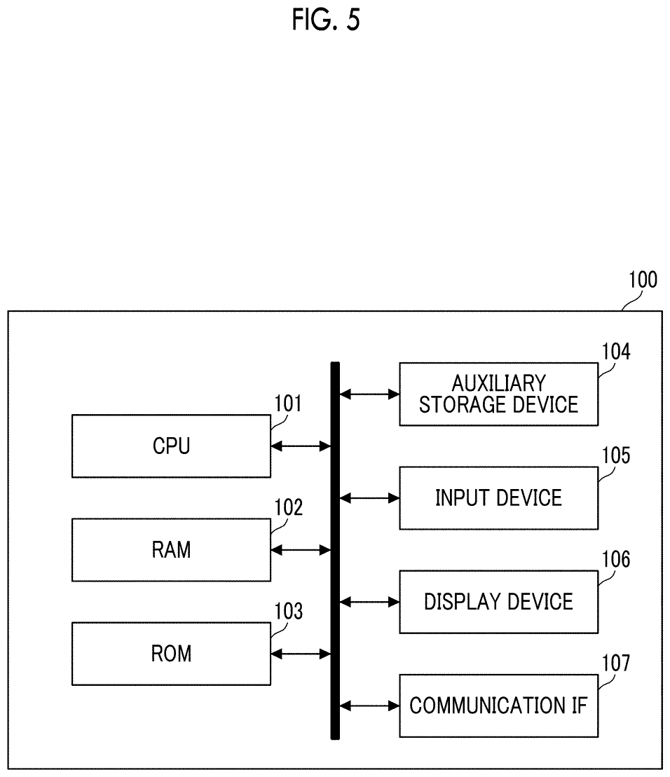

FIG. 5 is a block diagram showing an example of a hardware configuration of the control unit.

As shown in FIG. 5, the control unit 100 is configured with a so-called computer, and has a central processing unit (CPU) 101, a random access memory (RAM) 102, a read only memory (ROM) 103, an auxiliary storage device 104, an input device 105, a display device 106, a communication interface (IF) 107, and the like. The CPU 101 is an example of a processor. The RAM 102 is used as a work area of the CPU 101. The ROM 103 and/or the auxiliary storage device 104 store(s) a program executed by the CPU 101 and various data. The auxiliary storage device 104 is configured with, for example, a hard disk drive (HDD) or a solid state drive (SSD). The input device 105 is configured with, for example, a keyboard, a mouse, and a touch panel. The display device 106 is configured with, for example, a liquid crystal display or an organic light emitting diode display (organic EL display). The communication interface 107 is used for communication with an external device. Image data to be printed on the substrate 2 is acquired from an external device via the communication interface 107.

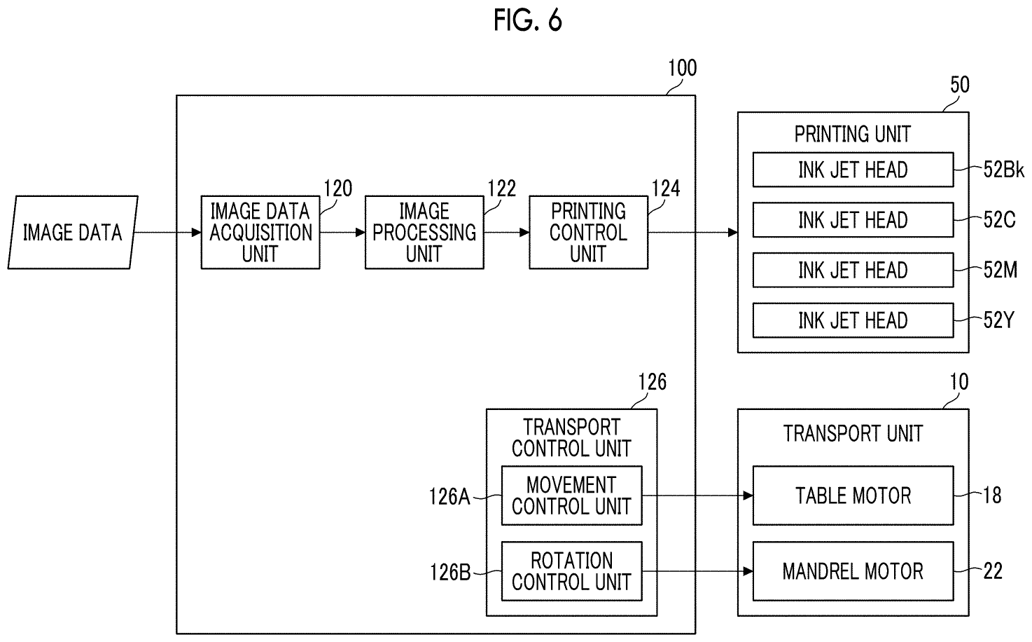

FIG. 6 is a block diagram showing main functions realized by the control unit.

The control unit 100 mainly functions as an image data acquisition unit 120, an image processing unit 122, a printing control unit 124, and a transport control unit 126. These functions are realized by the CPU 101 executing a predetermined program.

The image data acquisition unit 120 acquires image data to be printed on the outer circumferential surface of the substrate 2. The image data is acquired from an external device via the communication interface 107.

The image processing unit 122 processes the image data acquired by the image data acquisition unit 120 to generate printing data to be printed by the ink jet heads 52Bk, 52C, 52M, and 52Y. The printing data is generally generated by performing a color conversion process and a halftone process on image data. The color conversion process is a process of converting image data expressed in standard Red Green Blue (sRGB) or the like into ink amount data of each color used in the printer 1. The halftone process is a process of converting the ink amount data of each color generated through the color conversion process into dot data of each color by performing a process such as error diffusion. The dot data is data representing disposition of ink droplets. The dot data becomes printing data. Since the printer 1 of the present embodiment prints a color image by using ink of four colors such as black, cyan, magenta, and yellow, printing data of four colors such as black, cyan, magenta, and yellow is generated.

As will be described later, in the printer 1 of the present embodiment, a position where printing of an image is started on the outer circumferential surface of the substrate 2 differs depending on the stations St1 to St4. Therefore, the printing data of each color is generated according to a position where printing is started. This will be described later in detail.

The printing control unit 124 individually controls driving of each of the ink jet heads 52Bk, 52C, 52M, and 52Y on the basis of the printing data of each color generated by the image processing unit 122, and prints an image represented by the image data on the outer circumferential surface of the substrate 2. At the time of printing, the printing control unit 124 gives a trigger to start printing to each of the ink jet heads 52Bk, 52C, 52M, and 52Y to start a printing process. The trigger is given to the ink jet heads 52Bk, 52C, 52M, and 52Y at a timing at which a printing start position set on the outer circumferential surface of the substrate 2 reaches the printing position (refer to FIG. 4). This will be described later in detail.

The transport control unit 126 controls the transport unit 10 to control transport of the substrate 2. The control of transport of the substrate 2 includes control of movement of the substrate 2 and control of rotation of the substrate 2. Therefore, the transport control unit 126 has functions of a movement control unit 126A that controls movement of the substrate 2 and a rotation control unit 126B that controls rotation of the substrate 2. The movement control unit 126A controls driving of the table motor 18 to control movement of the substrate 2. The rotation control unit 126B controls driving of the mandrel motor 22 to control rotation of the substrate 2.

The rotation control unit 126B always rotates the substrate 2 at a constant rotation speed while the substrate 2 is being transported. The movement control unit 126A stops the movement of the substrate 2 at each of the stations St1 to St4. During this stoppage, the ink jet heads 52Bk, 52C, 52M, and 52Y provided in the respective stations St1 to St4 print images on the outer circumferential surface of the substrate 2. The movement control unit 126A restarts the movement at each of the stations St1 to St4 after the printing is completed.

Printing Process

Overview of Printing Process

As described above, in the printer 1 of the present embodiment, the substrate 2 is transported while being rotated at a constant speed, and images of respective colors are printed in order at the respective stations St1 to St4. At each of the stations St1 to St4, the movement is stopped while the rotation is continued. Images are printed on the outer circumferential surface of the substrate 2 that is being rotated with the ink jet heads 52Bk, 52C, 52M, and 52Y. At each of the stations St1 to St4, printing of the image is started from the printing start position set on the outer circumferential surface of the substrate 2. In the printer 1 of the present embodiment, printing start positions are set to two locations, and printing of the image is started from a printing start position that first reaches the printing position at each of the stations St1 to St4. Setting the printing start position is synonymous with setting a timing at which a trigger is given.

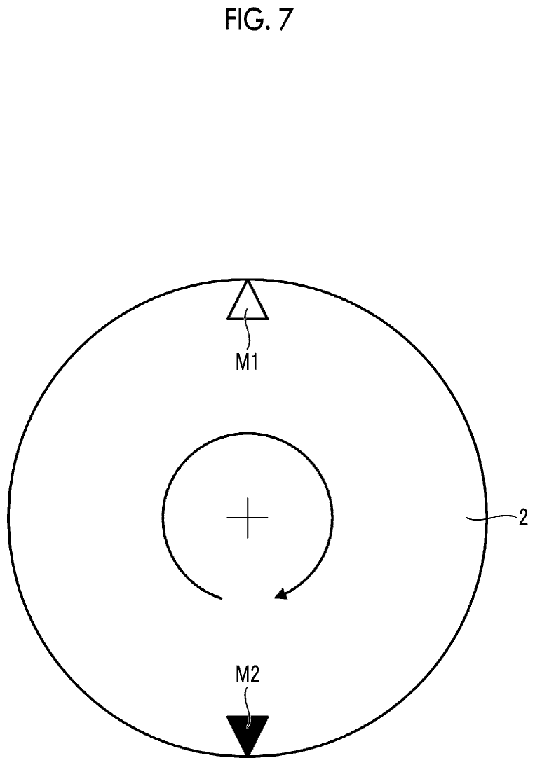

FIG. 7 is a diagram showing an example of setting a printing start position.

FIG. 7 shows an example in which printing start positions are set to two locations on the outer circumferential surface of the substrate 2. In FIG. 7, the positions indicated by triangular marks M1 and M2 are the printing start positions. Hereinafter, as necessary, the position indicated by the mark M1 will be referred to as a first printing start position and the position indicated by the mark M2 will be referred to as a second printing start position such that the two positions are distinguished from each other. As shown in FIG. 7, in the printer 1 of the present embodiment, the second printing start position is set to a position rotated by 0.5 in the direction opposite to the rotation direction of the substrate 2 (clockwise direction in FIG. 7) with respect to the first printing start position.

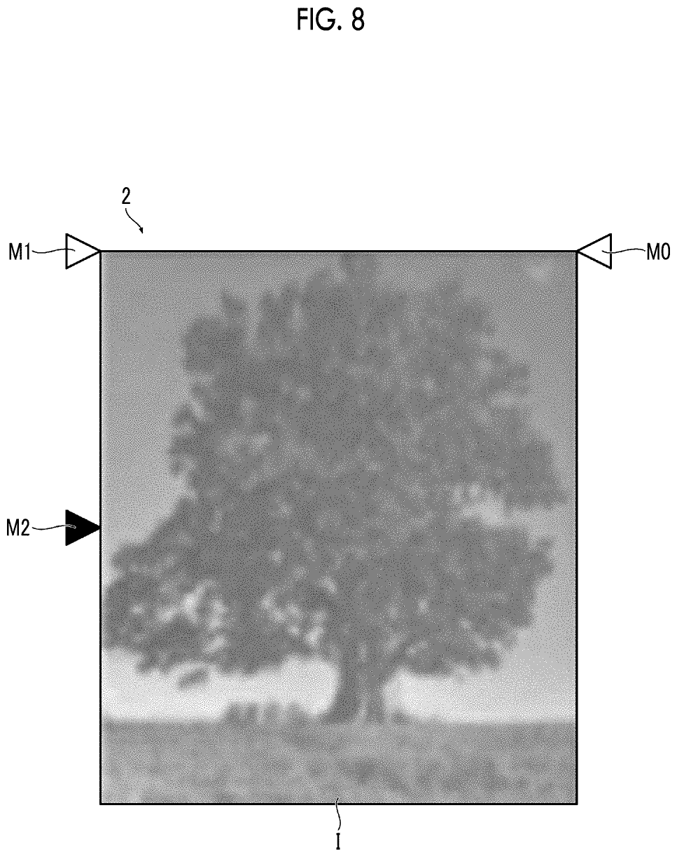

FIG. 8 is a developed view of the substrate on which an image is printed.

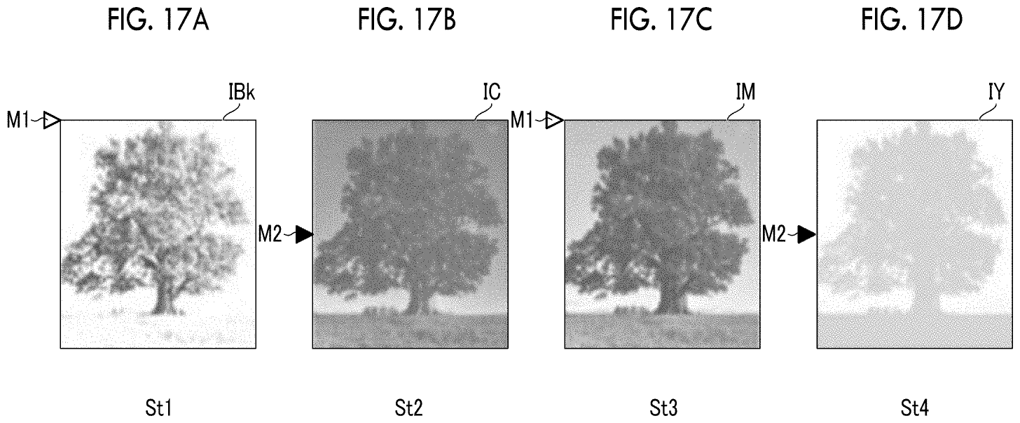

As described above, an image I is printed on the entire circumference of the substrate 2. In FIG. 8, the position indicated by a triangular mark M0 is a position where a front end of the image I is printed in the rotation direction of the substrate 2. As shown in FIG. 8, in the present embodiment, the first printing start position is set to the same position as the position where the front end of the image is printed. In this case, at the first printing start position, printing is started from the front end of the image (refer to FIGS. 17A and 17C). On the other hand, at the second printing start position, printing is started from a middle point of the image (a point of 50% from the front end of the image in the rotation direction of the substrate) (refer to FIGS. 17B and 17D).

As described above, at each of the stations St1 to St4, printing of the image is started from the printing start position that first reaches the printing position. Therefore, in a case where the first printing start position first reaches the printing position, printing is started from the first printing start position (refer to FIGS. 17A and 17C). In this case, printing is started from the front end of the image. On the other hand, in a case where the second printing start position first reaches the printing position, printing is started from the second printing start position. In this case, printing is started from a middle point of the image (refer to FIGS. 17B and 17D).

Specific Example of Printing Process

Hereinafter, a specific flow of a printing process of the printer 1 of the present embodiment will be described.

In the printer 1 of the present embodiment, each process is always performed by rotating the substrate 2 at a constant speed. The time for one rotation of the substrate 2 is denoted by T. T is a unit time. In the present embodiment, it is assumed that printing is completed for the time for one rotation of the substrate 2. Therefore, in the present embodiment, an image printing time at each of the stations St1 to St4 is T. The image printing time is a time during which image printing is executed at each station. The image printing time at each of the stations St1 to St4 is also a time from the start of printing the image to the start of movement to the next station at each of the stations St1 to St4.

The time for the substrate 2 to be moved between the stations is denoted by S. The time S is a transport time of the substrate 2 transported between the stations.

The substrate 2 before printing is supplied at a supply station (not shown) and mounted on the mandrel 20. In this case, the mandrel 20 is mounted such that the first printing start position and the second printing start position are located at predetermined positions. Consequently, it is possible to ascertain the first printing start position and the second printing position from a rotation amount of the mandrel 20.

At the first station St1, it is assumed that the first printing start position first reaches the printing position.

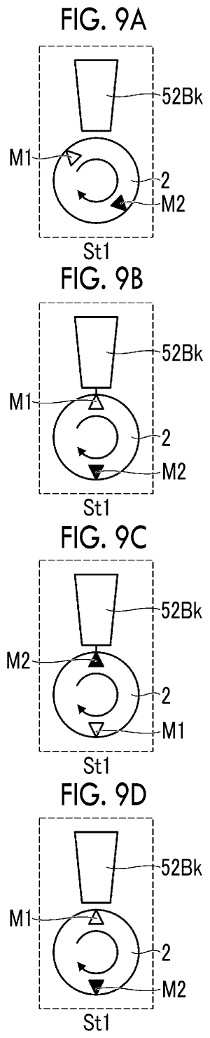

FIGS. 9A to 9D are diagrams showing a flow of a printing process at the first station.

FIG. 9A shows a state immediately after the substrate 2 arrives at the first station St1. The substrate 2 stops movement at a predetermined stop position while being rotated at a constant speed. By stopping the movement at the stop position, the substrate 2 is located directly below the ink jet head 52Bk.

FIG. 9B shows a state in which the first printing start position indicated by the mark M1 has reached the printing position. As described above, at the first station St1, the first printing start position first reaches the printing position. Printing is started at the same time as the first printing start position reaches the printing position. The printing control unit 124 gives a trigger to the ink jet head 52Bk at a timing at which the first printing start position reaches the printing position, and starts printing a black image. The image is printed from the front end (refer to FIG. 17A).

FIG. 9C shows a state after 0.5 T time has elapsed from the start of printing. That is, a state is shown in which the substrate 2 has been rotated by 0.5. After 0.5T time has elapsed from the start of printing, the second printing start position indicated by the mark M2 reaches the printing position. At this stage, a half of the image is printed.

FIG. 9D shows a state after T time has elapsed from the start of printing. That is, a state is shown in which the substrate 2 has been rotated once. Printing is finished in a case where the substrate 2 makes one rotation. Consequently, a black image is printed on the entire circumference of the substrate 2.

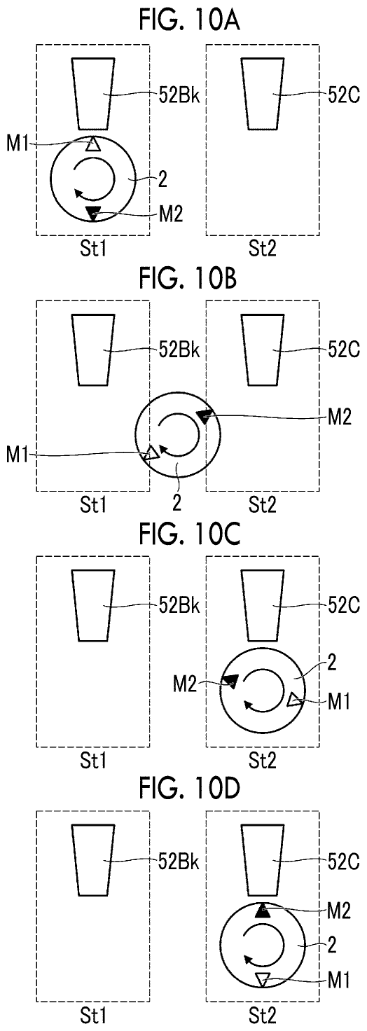

FIGS. 10A to 10D are diagrams showing a flow of a process of transporting the substrate from the first station to the second station.

FIG. 10A shows a state immediately after printing is finished at the first station St1. When printing is finished at the first station St1, the substrate 2 is stopped such that the first printing start position indicated by the mark M1 is located at the printing position. After printing at the first station St1 is finished, the substrate 2 starts to be moved toward the second station St2.

FIG. 10B shows a state in which the substrate 2 is being transported from the first station St1 to the second station St2. The substrate 2 is transported while constantly rotating at a constant speed. The substrate 2 arrives at the second station St2 S hours after the departure from the first station St1.

FIG. 10C shows a state immediately after the substrate 2 arrives at the second station St2. The substrate 2 stops movement at a predetermined stop position while being rotated at a constant speed. By stopping the movement at the stop position, the substrate 2 is located directly below the ink jet head 52C.

As shown in FIG. 10C, in the state immediately after the substrate 2 arrives at the second station St2, the second printing start position indicated by the mark M2 is located closer to the printing position than the first printing start position indicated by the mark M1. Therefore, at the second station St2, the second printing start position indicated by the mark M2 first reaches the printing position.

FIG. 10D shows a state in which a predetermined time has elapsed from the state shown in FIG. 10C and the second printing start position indicated by the mark M2 has reached the printing position.

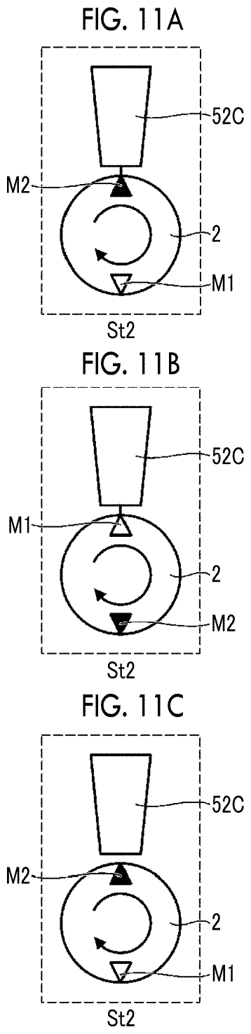

FIGS. 11A to 11C are diagrams showing a flow of a printing process at the second station.

FIG. 11A shows a state in which the second printing start position is located at the printing position. Printing is started at the same time as the second printing start position reaches the printing position. The printing control unit 124 gives a trigger to the ink jet head 52C at a timing at which the second printing start position reaches the printing position, and starts printing a cyan image. As described above, at the second printing start position, printing is started from a middle point of the image (a point of 50% in the rotation direction of the substrate from the front end of the image).

FIG. 11B shows a state after 0.5 T time has elapsed from the start of printing. That is, a state is shown in which the substrate 2 has been rotated by 0.5. After 0.5 T time has elapsed from the start of printing, the first printing start position indicated by the mark M1 reaches the printing position. At this stage, a half of the image is printed. Since printing is started from the middle point of the image at the second station St2, printing is started from the latter half of the image (refer to FIG. 17B).

FIG. 11C shows a state after T time has elapsed from the start of printing. That is, a state is shown in which the substrate 2 has been rotated once. Printing is finished in a case where the substrate 2 makes one rotation. Consequently, the cyan image is printed on the entire circumference of the substrate 2.

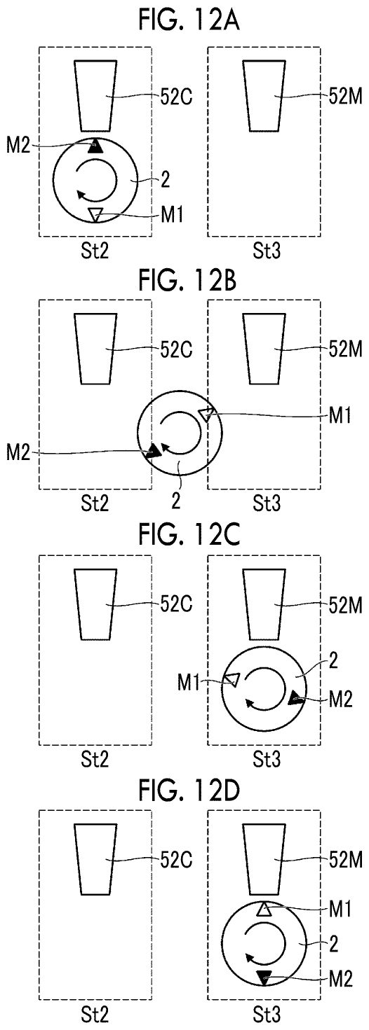

FIGS. 12A to 12D are diagrams showing a flow of a process of transporting the substrate from the second station to the third station.

FIG. 12A shows a state immediately after printing is finished at the second station St2. When printing is finished at the second station St2, the substrate 2 is stopped such that the second printing start position indicated by the mark M2 is located at the printing position. After printing at the second station St2 is finished, the substrate 2 starts to be moved toward the third station St3.

FIG. 12B shows a state in which the substrate 2 is being transported from the second station St2 to the third station St3. The substrate 2 is transported while constantly rotating at a constant speed. The substrate 2 arrives at the third station St3 S hours after the departure from the second station St2.

FIG. 12C shows a state immediately after the substrate 2 arrives at the third station St3. The substrate 2 stops movement at a predetermined stop position while being rotated at a constant speed. By stopping the movement at the stop position, the substrate 2 is located directly below the ink jet head 52M.

As shown in FIG. 12C, in the state immediately after the substrate 2 arrives at the third station St3, the first printing start position indicated by the mark M1 is located closer to the printing position than the second printing start position indicated by the mark M2. Therefore, at the third station St3, the first printing start position indicated by the mark M1 first reaches the printing position.

FIG. 12D shows a state in which a predetermined time has elapsed from the state shown in FIG. 12C and the first printing start position indicated by the mark M1 has reached the printing position.

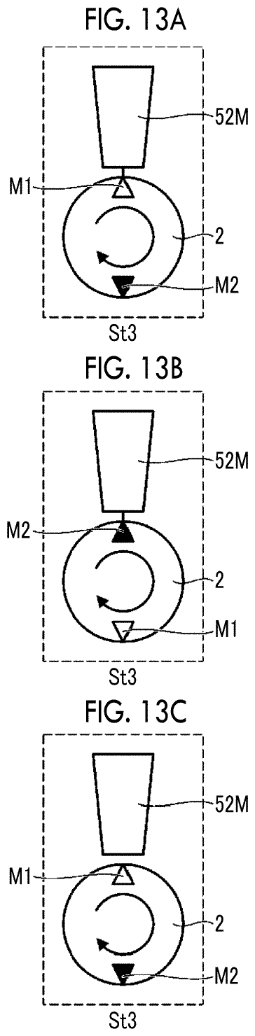

FIGS. 13A to 13C are diagrams showing a flow of printing process at the third station.

FIG. 13A shows a state in which the first printing start position is located at the printing position. Printing is started at the same time as the first printing start position reaches the printing position. The printing control unit 124 gives a trigger to the ink jet head 52M at a timing at which the first printing start position reaches the printing position, and starts printing a magenta image. As described above, at the first printing start position, printing is started from the front end of the image (refer to FIG. 17C).

FIG. 13B shows a state after 0.5 T time has elapsed from the start of printing. That is, a state is shown in which the substrate 2 has been rotated by 0.5. After 0.5 T time has elapsed from the start of printing, the first printing start position indicated by the mark M1 reaches the printing position. At this stage, a half of the image is printed.

FIG. 13C shows a state after T time has elapsed from the start of printing. That is, a state is shown in which the substrate 2 has been rotated once. Printing is finished in a case where the substrate 2 makes one rotation. Consequently, the magenta image is printed on the entire circumference of the substrate 2.

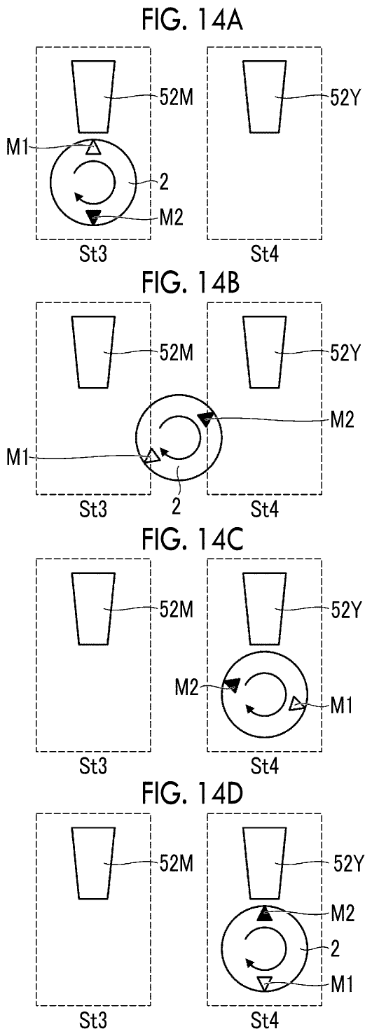

FIGS. 14A to 14D are diagrams showing a flow of a process of transporting the substrate from the third station to the fourth station.

FIG. 14A shows a state immediately after printing is finished at the third station St3. When printing is finished at the third station St3, the substrate 2 is stopped such that the first printing start position indicated by the mark M1 is located at the printing position. After printing at the third station St3 is finished, the substrate 2 starts to be moved toward the fourth station St4.

FIG. 14B shows a state in which the substrate 2 is being transported from the third station St3 to the fourth station St4. The substrate 2 is transported while constantly rotating at a constant speed. The substrate 2 arrives at the fourth station St4 S hours after the departure from the third station St3.

FIG. 14C shows a state immediately after the substrate 2 arrives at the fourth station St4. The substrate 2 stops movement at a predetermined stop position while being rotated at a constant speed. By stopping the movement at the stop position, the substrate 2 is located directly below the ink jet head 52Y.

As shown in FIG. 14C, in the state immediately after the substrate 2 arrives at the fourth station St4, the second printing start position indicated by the mark M2 is located closer to the printing position than the first printing start position indicated by the mark M1. Therefore, at the fourth station St4, the second printing start position indicated by the mark M2 first reaches the printing position.

FIG. 14D shows a state in which a predetermined time has elapsed from the state shown in FIG. 14C and the second printing start position indicated by the mark M2 has reached the printing position.

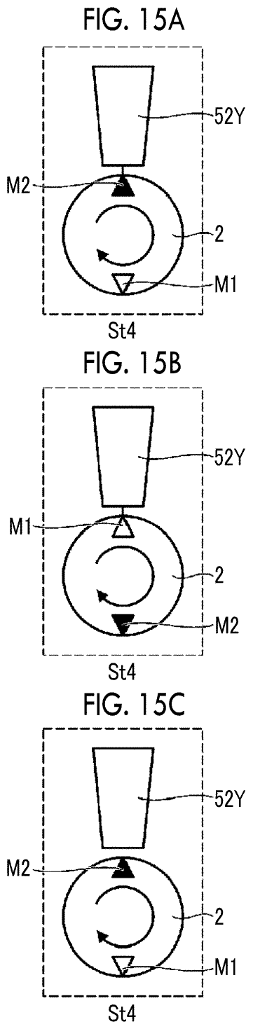

FIGS. 15A to 15D are diagrams showing a flow of printing process at the fourth station.

FIG. 15A shows a state in which the second printing start position is located at the printing position. Printing is started at the same time as the second printing start position reaches the printing position. The printing control unit 124 gives a trigger to the ink jet head 52Y at a timing at which the second printing start position reaches the printing position, and starts printing a yellow image. As described above, at the second printing start position, printing is started from a middle point of the image (a point of 50% from the front end of the image in the rotation direction of the substrate) (refer to FIG. 17 (D)).

FIG. 15B shows a state after 0.5 T time has elapsed from the start of printing. That is, a state is shown in which the substrate 2 has been rotated by 0.5. After 0.5 T time has elapsed from the start of printing, the first printing start position indicated by the mark M1 reaches the printing position. At this stage, a half of the image is printed. Since printing is started from the middle point of the image at the fourth station St4, the latter half of the image is printed.

FIG. 15C shows a state after T time has elapsed from the start of printing. That is, a state is shown in which the substrate 2 has been rotated once. Printing is finished in a case where the substrate 2 makes one rotation. Consequently, the yellow image is printed on the entire circumference of the substrate 2.

In the above series of steps, black, cyan, magenta, and yellow images are printed on the outer circumferential surface of the substrate 2. Consequently, a color image is printed.

After the printing at the fourth station St4 is finished, the substrate 2 starts to be moved toward the collecting station. The substrate 2 is detached from the mandrel 20 and collected at the collecting station.

As described above, in the printer 1 of the present embodiment, the printing start positions are set to two locations, and printing of an image is started from the printing start position that first reaches the printing position at each station. Consequently, at each station, the waiting time until the start of printing (the time from when the substrate arrives at the station to when printing an image is started) can be reduced, and thus the image can be efficiently printed on the outer circumferential surface of the cylindrical substrate. Since a printing timing is only controlled, printing can be performed with simple control.

### Comparative Example

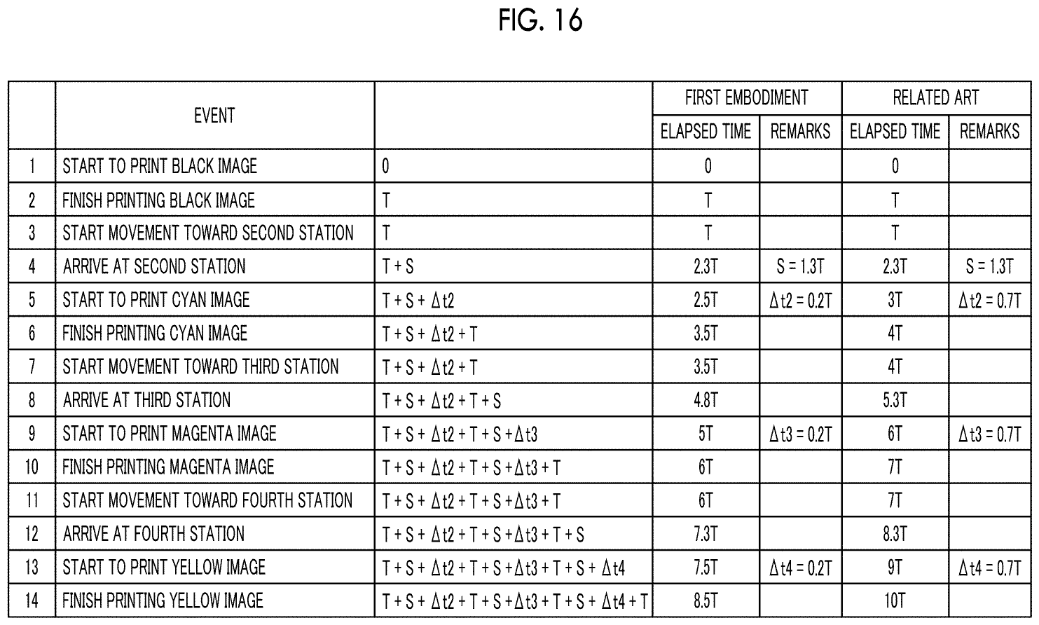

FIG. 16 is a table in which a difference in processing efficiency between a control method of the related art and the control method of the present embodiment. In FIG. 16, a difference in the elapsed time from the start of printing a black image to the completion of printing a yellow image is compared.

Here, the control method of the related art to be compared is a control method in which printing is always started from a front end position of an image at each station. In other words, the control method of the related art is a control method in a case where only one printing start position is set.

The time for one rotation of the substrate 2 is denoted by T, and the time for the substrate 2 to be moved between the stations is denoted by S. The time T and the time S are common times between the control method of the related art and the control method of the present embodiment. Here, it is assumed that the time S is 1.3 times the time T. That is, it is assumed that S=1.3T. Since an image is printed on the entire circumference of the substrate 2, the printing time at each of the stations St1 to St4 is T.

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0].

(2) Printing of the black image is finished at the first station St1. The image is printed on the entire circumference of the substrate 2. Therefore, the elapsed time is [T]. That is, the image printing time is the elapsed time. In the case of this example, the time T for one rotation of the substrate 2 is the printing time, and thus the time T is the elapsed time.

(3) The substrate 2 starts to be moved toward the second station St2. Since the movement is started at the same time as printing is finished, the elapsed time is [T].

(4) The substrate 2 arrives at the second station St2. The transport time of the substrate 2 between the stations is S. Therefore, the elapsed time is [T+S] with the addition of the transport time S. Here, since S=1.3T, T+S=T+1.3T=2.3T.

(5) Printing of the cyan image is started at the second station St2. Here, the time from when the substrate 2 arrives at the second station St2 to when printing of the cyan image is started is denoted by Δt2. Δt2 is the waiting time at the second station St2. Therefore, at the second station St2, the elapsed time until the printing of the cyan image is started is [T+S+Δt2] with the addition of the waiting time St2.

In the control method of the related art, printing is always started from the front end position of the image. Therefore, the waiting time Δt2 is 0.7T. Therefore, the elapsed time in a case where printing is performed according to the control method of the related art is T+S+Δt2=T+1.3T+0.7T=3T.

On the other hand, in the control method of the present embodiment, printing is started from the second printing start position at the second station St2. The second printing start position is set to a position rotated by 0.5 from the first printing start position. Therefore, in the control method of the present embodiment, Δt2=0.2T. Therefore, the elapsed time in a case where printing is performed according to the control method of the present embodiment is T+S+Δt2=T+1.3T+0.2T=2.5T. Therefore, at this time point, the time is reduced by 0.5T compared with the control method of the related art.

(6) At the second station St2, printing of the cyan image is finished. The elapsed time is [T+S+Δt2+T] with the addition of the printing time T (=the time for one rotation of the substrate 2).

The elapsed time in a case where printing is preformed according to the control method of the related art is T+S+Δt2+T=T+1.3T+0.7T+T=4T.

On the other hand, the elapsed time in a case where printing is preformed according to the control method of the present embodiment is T+S+Δt2+T=T+1.3T+0.2T+T=3.5T.

(7) The substrate 2 starts to be moved toward the third station St3. Since the movement is started at the same time as printing is finished, the elapsed time is [T+S+Δt2+T], which is the same as when printing is finished.

Therefore, the elapsed time in a case where printing is preformed according to the control method of the related art is T+S+Δt2+T=T+1.3T+0.7T+T=4T.

On the other hand, the elapsed time in a case where printing is preformed according to the control method of the present embodiment is T+S+Δt2+T=T+1.3T+0.2T+T=3.5T.

(8) The substrate 2 arrives at the third station St3. The transport time of the substrate 2 is S. Therefore, the elapsed time is [T+S+Δt2+T+S] with the addition of the transport time S.

The elapsed time in a case where printing is preformed according to the control method of the related art is T+S+Δt2+T+S=T+1.3T+0.7T+T+1.3T=5.3T.

On the other hand, the elapsed time in a case where printing is preformed according to the control method of the present embodiment is T+S+Δt2+T+S=T+1.3T+0.2T+T+1.3T=4.8T.

(9) Printing of the magenta image is started at the third station St3. Here, the time from when the substrate 2 arrives at the third station St3 to when printing of the magenta image is started is denoted by Δt3. Δt3 is the waiting time at the third station St3. At the third station St3, the elapsed time until printing of the magenta image is started is [T+S+Δt2+T+S+Δt3] with the addition of the waiting time Δt3.

The waiting time Δt3 in the control method of the related art is 0.7T. Therefore, the elapsed time in a case where printing is preformed according to the control method of the related art is T+S+Δt2+T+S+Δt3=T+1.3T+0.7T+T+1.3T+0.7T=6T.

On the other hand, in the control method of the present embodiment, printing is started from the first printing start position at the third station St3. The first printing start position is set to a position rotated by 0.5 from the second printing start position. Therefore, in the control method of the present embodiment, Δt2=0.2T. Therefore, the elapsed time in a case where printing is preformed according to the control method of the present embodiment is T+S+Δt2+T+S+Δt3=T+1.3T+0.2T+T+1.3T+0.2T=5T.

(10) At the third station St3, printing of the magenta image is finished. The elapsed time is [T+S+Δt2+T+S+Δt3+T] with the addition of the printing time T (=the time for one rotation of the substrate 2).

The elapsed time in a case where printing is preformed according to the control method of the related art is T+S+Δt2+T+S+Δt3+T=T+1.3T+0.7T+T+1.3T+0.7T+T=7T.

On the other hand, the elapsed time in a case where printing is preformed according to the control method of the present embodiment is T+S+Δt2+T+S+Δt3+T=T+1.3T+0.2T+T+1.3T+0.2T+T=6T.

(11) The substrate 2 starts to be moved toward the fourth station St4. Since the movement is started at the same time as printing is finished, the elapsed time is the same as when printing is finished, which is [T+S+Δt2+T+S+Δt3+T].

Therefore, the elapsed time in a case where printing is preformed according to the control method of the related art is T+S+Δt2+T+S+Δt3+T=T+1.3T+0.7T+T+1.3T+0.7T+T=7T.

On the other hand, the elapsed time in a case where printing is preformed according to the control method of the present embodiment is T+S+Δt2+T+S+Δt3+T=T+1.3T+0.2T+T+1.3T+0.2T+T=6T.

(12) The substrate 2 arrives at the fourth station St4. The transport time of the substrate 2 is S. Therefore, the elapsed time is [T+S+Δt2+T+S+Δt3+T+S] with the addition of the transport time S.

The elapsed time in a case where printing is preformed according to the control method of the related art is T+S+Δt2+T+S+Δt3+T+S=T+1.3T+0.7T+T+1.3T+0.7T+T+1.3T=8.3T.

On the other hand, the elapsed time in a case where printing is preformed according to the control method of the present embodiment is T+S+Δt2+T+S+Δt3+T+S=T+1.3T+0.2T+T+1.3T+0.2T+T+1.3T=7.3T.

(13) Printing of the yellow image is started at the fourth station St4. Here, the time from when the substrate 2 arrives at the fourth station St4 to when the printing of the yellow image is started is denoted by Δt4. Δt4 is the waiting time at the fourth station St4. At the fourth station St4, the elapsed time until printing of the yellow image is started is [T+S+Δt2+T+S+Δt3+T+S+Δt4] with the addition of the waiting time Δt4.

The waiting time Δt4 in the control method of the related art is 0.7T. Therefore, the elapsed time in a case where printing is preformed according to the control method of the related art is T+S+Δt2+T+S+Δt3+T+S+Δt4=T+1.3T+0.7T+T+1.3T+0.7T+T+1.3T+0.7T=9T.

On the other hand, in the control method of the present embodiment, printing is started from the second printing start position at the fourth station St4. The second printing start position is set to a position rotated by 0.5 from the first printing start position. Therefore, in the control method of the present embodiment, Δt2=0.2T. Therefore, the elapsed time in a case where printing is preformed according to the control method of the present embodiment is T+S+Δt2+T+S+Δt3+T+S+Δt4=T+1.3T+0.2T+T+1.3T+0.2T+T+1.3T+0.2T=7.5T.

(14) At the fourth station St4, printing of the yellow image is finished. The elapsed time is [T+S+Δt2+T+S+Δt3+T+S+Δt4+T] with the addition of the printing time T (=the time for one rotation of the substrate 2).

The elapsed time in a case where printing is preformed according to the control method of the related art is T+S+Δt2+T+S+Δt3+T+S+Δt4+T=T+1.3T+0.7T+T+1.3T+0.7T+T+1.3T+0.7T+T=10T.

On the other hand, the elapsed time in a case where printing is preformed according to the control method of the present embodiment is T+S+Δt2+T+S+Δt3+T+S+Δt4+T=T+1.3T+0.2T+T+1.3T+0.2T+T+1.3T+0.2T+T=8.5T.

As described above, according to the control method of the present embodiment, the waiting time can be reduced at each station after the second station. As a result, the overall printing time can be reduced compared with the control method of the related art. Specifically, a total printing time of the control method of the related art is 10T, whereas a total printing time of the control method of the present embodiment is 8.5T. Therefore, the time can be reduced by 1.5T. That is, the time can be reduced by 15%.

The transport speed of the substrate 2 can be arbitrarily set regardless of the layout of the station or the like. Therefore, it is possible to transport the substrate 2 at the highest speed that can be set by the transport unit 10. Consequently, the processing efficiency can be further improved.

The most efficient printing is printing without a waiting time, but stable control can be realized by providing a predetermined waiting time at each station as in the printer of the present embodiment. That is, in order to print an image at each station without waiting time, it is necessary to control both rotation and movement of the substrate 2 with high accuracy. By providing a waiting time, errors (arrival delay, advancing, and the like) that occur during movement can be absorbed, and stable control can be realized. The method of performing printing without waiting time will be described later.

Printing Data

FIGS. 17A to 17D are diagrams showing an example of an image printed on the outer circumferential surface of the substrate at each station.

As shown in FIG. 17A, at the first station St1, a black image IBk is printed on the outer circumferential surface of the substrate. As shown in FIG. 17B, at the second station St2, a cyan image IC is printed on the outer circumferential surface of the substrate. As shown in FIG. 17C, at the third station St3, a magenta image IM is printed on the outer circumferential surface of the substrate. As shown in FIG. 17D, at the fourth station St4, a yellow image IY is printed on the outer circumferential surface of the substrate.

At the first station St1, as shown in FIG. 17A, printing of the image is started from the first printing start position indicated by the mark M1. The first printing start position is set to the same position on the outer circumferential surface of the substrate as the position where the front end of the image is printed. Therefore, at the first station St1, printing is started from the front end of the image. Similarly, at the third station St3, printing of the image is started from the first printing start position (refer to FIG. 17C). Therefore, also at the third station St3, printing is started from the front end of the image.

On the other hand, at the second station St2 and the fourth station St4, as shown in FIGS. 17B and 17D, printing of the image is started from the second printing start position indicated by the mark M2. The second printing start position is set to a position rotated by 0.5 from the first printing start position. Therefore, at the second station St2 and the fourth station St4, printing is started from a middle point of the image (a point of 50% in the rotation direction of the substrate from the front end of the image).

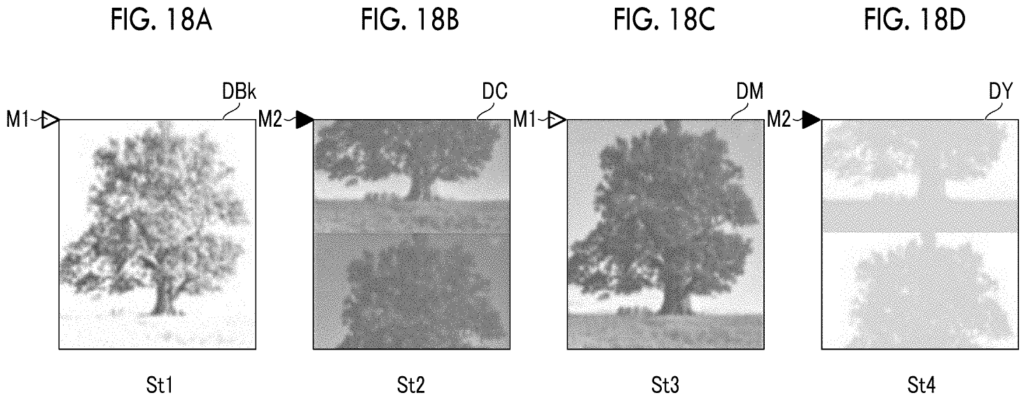

FIGS. 18A to 18 are conceptual diagrams of printing data of an image printed on the outer circumferential surface of the substrate at the respective stations.

As described above, at the first station St1, printing is started from the front end of the image. Therefore, as printing data DBk for printing the black image at the first station St1, data for printing the black image from the front end is generated as shown in FIG. 18A.

Similarly, printing is started from the front end of the image at the third station St3, and thus, as printing data DM for printing the magenta image at the third station St3, data for printing the magenta image from the front end is generated as shown in FIG. 18C.

On the other hand, at the second station St2, printing is started from a middle point of the image. Therefore, as data DC for printing the cyan image at the second station St2, data for printing the cyan image from the middle point is generated as shown in FIG. 18B. This data has a structure in which the cyan image IC is divided into two parts in the front-rear direction at the second printing start position, and the first half part is connected to the back of the second half part.

Similarly, at the fourth station St4, printing is started from the front end of the image. Therefore, as printing data DY for printing the yellow image at the fourth station St4, data for printing the yellow image from the middle point is generated as shown in FIG. 18D.

### Modification Example

Number of Printing Start Positions

In the above embodiment, printing start positions are set at two locations on the outer circumferential surface of the substrate 2. The number of printing start positions set on the outer circumferential surface of the substrate 2 is not limited to this. A printing start position may be set as appropriate according to the number of stations, a rotation speed of the substrate 2, a transport speed of the substrate 2, and the like.

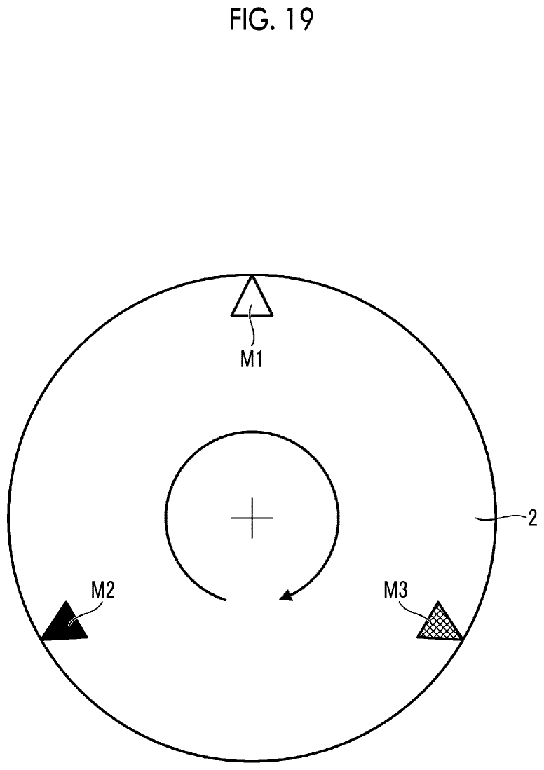

FIG. 19 is a diagram showing another example of setting a printing start position.

FIG. 19 shows an example in which printing start positions are set at three locations on the outer circumferential surface of the substrate 2. In FIG. 19, the positions indicated by the triangular marks M1, M2, and M3 are the printing start positions. The printing start position indicated by the mark M1 is a first printing start position, the printing start position indicated by the mark M2 is a second printing start position, and the printing start position indicated by the mark M3 is a third printing start position. The second printing start position is set to a position rotated by 0.33 from the first printing start position. The third printing start position is set to a position rotated by 0.34 from the second printing start position. The first printing start position is set to a position rotated by 0.33 from the third printing start position.

The time for one rotation of the substrate 2 is denoted by T. It is assumed that the time for the substrate 2 to be moved between the stations is denoted by S, and S=1.3T.

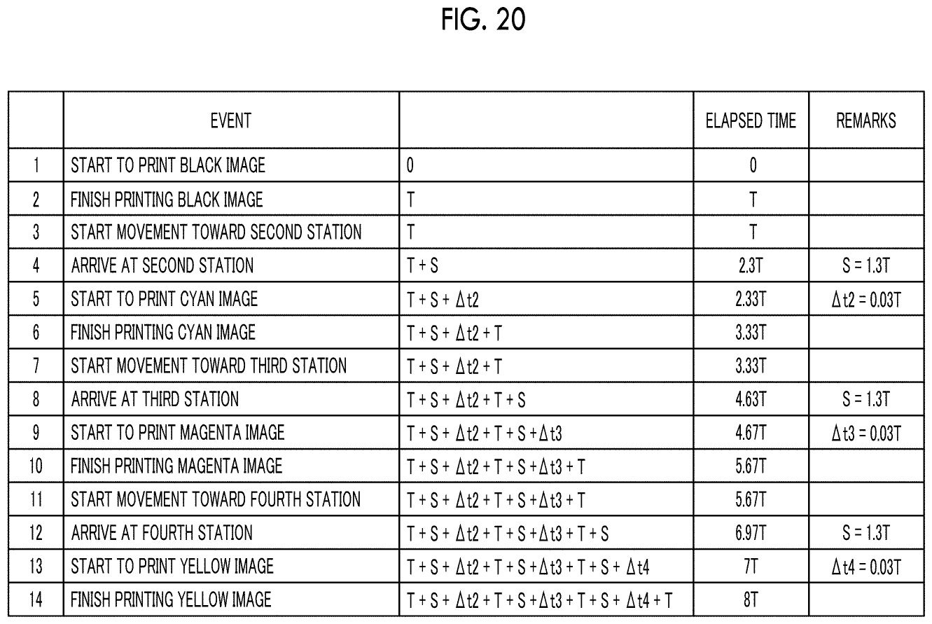

FIG. 20 is a table showing a flow and elapsed time of a series of printing processes in a case where the printing start positions are set to three locations.

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [T] with the addition of the printing time T (=the time for one rotation of the substrate 2).

(3) The substrate 2 starts to be moved toward the second station St2. Since the movement is started at the same time as printing is finished, the elapsed time is [T].

(4) The substrate 2 arrives at the second station St2. The elapsed time is [T+S] with the addition of the transport time S. Since S=1.3T, T+S=T+1.3T=2.3T.

(5) Printing of the cyan image is started at the second station St2. The time (waiting time) from when the substrate 2 arrives at the second station St2 to when printing of the cyan image is started is denoted by Δt2. The elapsed time is [T+S+Δt2] with the addition of the waiting time Δt2.

Here, at a time point at which the substrate 2 arrives at the second station St2, the position rotated by 0.3 from the first printing start position is located at the printing position. A printing start position closest to the printing position at the time point at which the substrate 2 arrives at the second station St2 is the second printing start position. The second printing start position is set to a position rotated by 0.33 from the first printing start position. Therefore, the waiting time Δt2 is 0.03T. Therefore, the elapsed time in this example is T+S+Δt2=T+1.3T+0.03T=2.33T.

(6) At the second station St2, printing of the cyan image is finished. The elapsed time is [T+S+Δt2+T] with the addition of the printing time T (=the time for one rotation of the substrate 2). Therefore, the elapsed time in this example is T+S+Δt2+T=T+1.3T+0.03T+T=3.33T.

(7) The substrate 2 starts to be moved toward the third station St3. Since the movement is started at the same time as printing is finished, the elapsed time is [T+S+Δt2+T], which is the same as when printing is finished. Therefore, the elapsed time in this example is T+S+Δt2+T=T+1.3T+0.03T+T=3.33T.

(8) The substrate 2 arrives at the third station St3. The elapsed time is [T+S+Δt2+T+S] with the addition of the transport time S. Therefore, the elapsed time in this example is T+S+Δt2+T+S=T+1.3T+0.03T+T+1.3T=4.63T.

(9) Printing of the magenta image is started at the third station St3. The time (waiting time) from when the substrate 2 arrives at the third station St3 to when printing of the cyan image is started is denoted by Δt3. The elapsed time is [T+S+Δt2+T+S+Δt3] with the addition of the waiting time Δt3.

Here, at a time point at which the substrate 2 arrives at the third station St3, a position rotated by 0.3 from the second printing start position is located at the printing position. A printing start position closest to the printing position at the time point at which the substrate 2 arrives at the third station St3 is the third printing start position. The third printing start position is set to a position rotated by 0.34 from the second printing start position. Therefore, the waiting time Δt3 is 0.04T. Therefore, the elapsed time in this example is T+S+Δt2+T+S+Δt3=T+1.3T+0.03T+T+1.3T+0.04T=4.67T.

(10) At the third station St3, printing of the magenta image is finished. The elapsed time is [T+S+Δt2+T+S+Δt3+T] with the addition of the printing time T (=the time for one rotation of the substrate 2). Therefore, the elapsed time in this example is T+S+Δt2+T+S+Δt3+T=T+1.3T+0.03T+T+1.3T+0.04T+T=5.67T.

(11) The substrate 2 starts to be moved toward the fourth station St4. Since the movement is started at the same time as printing is finished, the elapsed time is the same as when printing is finished, which is [T+S+Δt2+T+S+Δt3+T]. Therefore, the elapsed time in this example is T+S+Δt2+T+S+Δt3+T=T+1.3T+0.03T+T+1.3T+0.04T+T=5.67T.

(12) The substrate 2 arrives at the fourth station St4. The elapsed time is [T+S+Δt2+T+S+Δt3+T+S] with the addition of the transport time S. Therefore, the elapsed time of this example is T+S+Δt2+T+S+Δt3+T+S=T+1.3T+0.03T+T+1.3T+0.04T+T+1.3T=6.97T.

(13) Printing of the yellow image is started at the fourth station St4. The time (waiting time) from when the substrate 2 arrives at the fourth station St4 to when printing the yellow image is started is denoted by Δt4. The elapsed time is [T+S+Δt2+T+S+Δt3+T+S+Δt4] with the addition of the waiting time Δt4.

Here, at a time point at which the substrate 2 arrives at the fourth station St4, a position rotated by 0.3 from the third printing start position is located at the printing position. A printing start position closest to the printing position at the time point at which the substrate 2 arrives at the fourth station St4 is the first printing start position. The first printing start position is set to a position rotated by 0.33 from the third printing start position. Therefore, the waiting time Δt4 is 0.03T. Therefore, the elapsed time in this example is T+S+Δt2+T+S+Δt3+T+S+Δt4=T+1.3T+0.03T+T+1.3T+0.04T+T+1.3T+0.03T=7T.

(14) At the fourth station St4, printing of the yellow image is finished. The elapsed time is [T+S+Δt2+T+S+Δt3+T+S+Δt4+T] with the addition of the printing time T (=the time for one rotation of the substrate 2). Therefore, the elapsed time of this example is T+S+Δt2+T+S+Δt3+T+S+Δt4+T=T+1.3T+0.03T+T+1.3T+0.04T+T+1.3T+0.03T+T=8T.

As described above, according to the control method of this example, the waiting time can be further reduced at each station after the second station. Consequently, the overall printing time can be further reduced.

Print Start Position Setting Location

In the above embodiment, the printing start positions are set at equal intervals, but a printing start position setting location is not limited to this. A printing start position setting location may be as appropriate adjusted according to setting intervals of stations, a rotation speed of the substrate 2, a transport speed of the substrate 2, and the like.

Image Printing Range

In the above embodiment, the case where an image is printed on the entire circumference of the substrate has been described as an example, but an image does not necessarily have to be printed on the entire circumference of the substrate. An image may be printed only on a partial region in the circumferential direction. In a case where an image is printed only on a partial region in the circumferential direction, movement to the next station is started in a stage in which the printing of the image has been completed. Therefore, in this case, it is preferable to set a printing start position in consideration of a range in which the image is printed on the outer circumferential surface of the substrate. Hereinafter, a process example in which the image is printed only on a partial region of the outer circumferential surface of the substrate will be described.

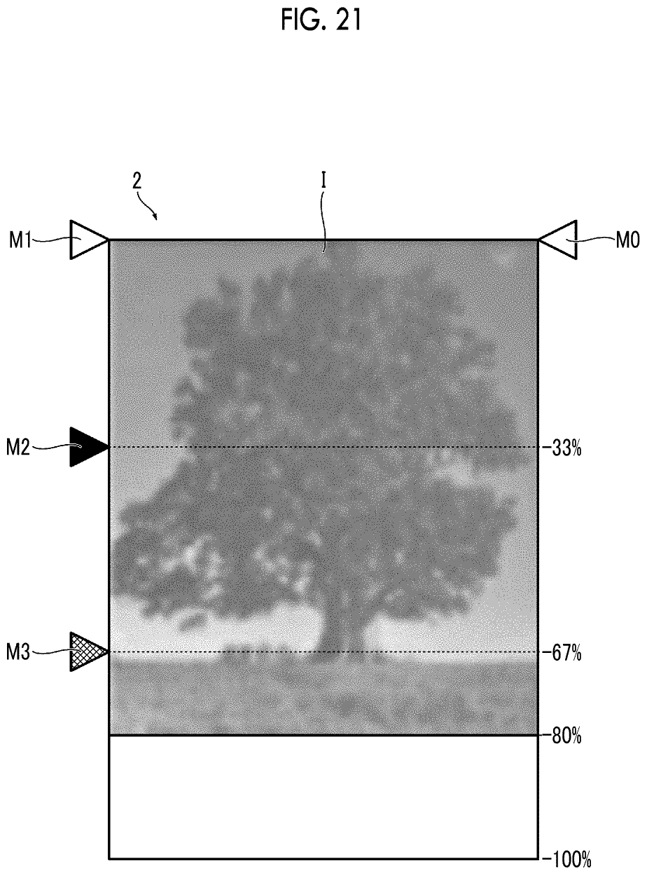

FIG. 21 is a developed view of the substrate on which an image is printed.

As shown in FIG. 21, in this example, it is assumed that an image I is printed in a range of 80% in the circumferential direction. In FIG. 21, a position indicated by a triangular mark M0 is a position where the front end of the image I is printed.

As shown in FIG. 21, in this example, it is assumed that printing start positions are set to three locations on the outer circumferential surface of the substrate 2. In FIG. 21, a position indicated by the triangular mark M1 is a first printing start position setting position. A position indicated by the triangular mark M2 is a second printing start position setting position. A position indicated by the triangular mark M3 is a third printing start position setting position. The first printing start position is set to the same position as the position where the front end of the image is printed. The second printing start position is set to a position rotated by 0.33 from the first printing start position (a point of 33% from the front end of the image in the rotation direction of the substrate). The third printing start position is set to a position rotated by 0.34 from the second printing start position (a point of 67% from the front end of the image in the rotation direction of the substrate).

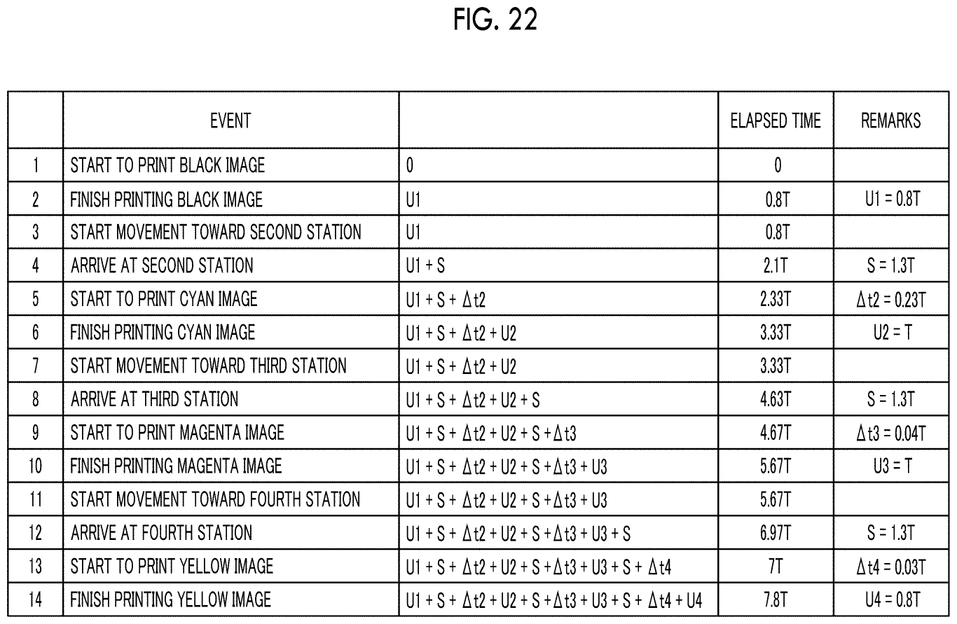

FIG. 22 is a table showing a flow and elapsed time of a series of printing processes.

In this example, the time for one rotation of the substrate 2 is denoted by T. It is assumed that the time for the substrate 2 to be moved between the stations is denoted by S, and S=1.3T. The printing time of an image at an n-th station is denoted by Un.

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [U1] with the addition of the printing time U1. Here, as described above, at the first station St1, printing is started from the first printing start position. The first printing start position is set to the same position as the position where the front end of the image is printed. Therefore, the printing time U1 at the first station St1 is U1=0.8T. Therefore, the elapsed time is 0.8T.

(3) The substrate 2 starts to be moved toward the second station St2. Since the movement is started at the same time as printing is finished, the elapsed time is [U1]. In the case of this example, the elapsed time is 0.8T.

(4) The substrate 2 arrives at the second station St2. The elapsed time is [T+S] with the addition of the transport time S. Since S=1.3T, U1+S=0.8T+1.3T=2.1T.

(5) Printing of the cyan image is started at the second station St2. The time (waiting time) from when the substrate 2 arrives at the second station St2 to when printing of the cyan image is started is denoted by Δt2. The elapsed time is [U1+S+Δt2] with the addition of the waiting time Δt2.

Here, at a time point at which the substrate 2 arrives at the second station St2, a position rotated by 0.1 from the first printing start position is located at the printing position. A printing start position closest to the printing position at the time point at which the substrate 2 arrives at the second station St2 is the second printing start position. The second printing start position is set to a position rotated by 0.33 from the first printing start position. Therefore, the waiting time Δt2 is 0.23T. Therefore, the elapsed time in this example is U1+S+Δt2=0.8T+1.3T+0.23T=2.33T.

(6) At the second station St2, printing of the cyan image is finished. The elapsed time is [U1+S+Δt2+U2] with the addition of the printing time U2 at the second station St2. Here, at the second station St2, printing is started from the second printing start position. The second printing start position is set to a position of 0.33% in the circumferential direction from the front end of the image. Therefore, the printing time U2 at the second station St2 is U2=T. Therefore, the elapsed time in this example is U1+S+Δt2+U2=0.8T+1.3T+0.23T+T=3.33T.

(7) The substrate 2 starts to be moved toward the third station St3. Since the movement is started at the same time as printing is finished, the elapsed time is [U1+S+Δt2+U2], which is the same as when printing is finished. Therefore, the elapsed time in this example is U1+S+Δt2+U2=0.8T+1.3T+0.23T+T=3.33T.

(8) The substrate 2 arrives at the third station St3. The elapsed time is [U1+S+Δt2+U2+S] with the addition of the transport time S. Therefore, the elapsed time in this example is U1+S+Δt2+U2+S=0.8T+1.3T+0.23T+T+1.3T=4.63T.

(9) Printing of the magenta image is started at the third station St3. The time (waiting time) from when the substrate 2 arrives at the third station St3 to when printing of the cyan image is started is denoted by Δt3. The elapsed time is [U1+S+Δt2+U2+S+Δt3] with the addition of the waiting time Δt3.

Here, at a time point at which the substrate 2 arrives at the third station St3, a position rotated by 0.3 from the second printing start position is located at the printing position. A printing start position closest to the printing position at the time point at which the substrate 2 arrives at the third station St3 is the third printing start position. The third printing start position is set to a position rotated by 0.34 from the second printing start position. Therefore, the waiting time Δt3 is 0.04T. Therefore, the elapsed time in this example is U1+S+Δt2+U2+S+Δt3=0.8T+1.3T+0.23T+T+1.3T+0.04T=4.67T.

(10) At the third station St3, printing of the magenta image is finished. The elapsed time is [U1+S+Δt2+U2+S+Δt3+U3] with the addition of the printing time U3 at the third station St3. Here, at the second station St2, printing is started from the second printing start position. The second printing start position is set to a position of 0.33% in the circumferential direction from the front end of the image. Therefore, the printing time U2 at the second station St2 is U2=T. Therefore, the elapsed time in this example is U1+S+Δt2+U2+S+Δt3+U3=0.8T+1.3T+0.23T+T+1.3T+0.04T+T=5.67T.

(11) The substrate 2 starts to be moved toward the fourth station St4. Since the movement is started at the same time as printing is finished, the elapsed time is [U1+S+Δt2+U2+S+Δt3+U3], which is the same as when printing is finished. Therefore, the elapsed time in this example is U1+S+Δt2+U2+S+Δt3+U3=0.8T+1.3T+0.23T+T+1.3T+0.04T+T=5.67T.

(12) The substrate 2 arrives at the fourth station St4. The elapsed time is [U1+S+Δt2+U2+S+Δt3+U3+S] with the addition of the transport time S. Therefore, the elapsed time in this example is U1+S+Δt2+U2+S+Δt3+U3+S=0.8T+1.3T+0.23T+T+1.3T+0.04T+T+1.3T=6.97T.

(13) Printing of the yellow image is started at the fourth station St4. The time (waiting time) from when the substrate 2 arrives at the fourth station St4 to when printing the yellow image is started is denoted by Δt4. The elapsed time is [U1+S+Δt2+U2+S+Δt3+U3+S+Δt4] with the addition of the waiting time Δt4.

Here, at a time point at which the substrate 2 arrives at the fourth station St4, a position rotated by 0.3 from the third printing start position is located at the printing position. A printing start position closest to the printing position at the time point at which the substrate 2 arrives at the fourth station St4 is the first printing start position. The first printing start position is set to a position rotated by 0.33 from the third printing start position. Therefore, the waiting time Δt4 is 0.03T. Therefore, the elapsed time in this example is U1+S+Δt2+U2+S+Δt3+U3+S+Δt4=0.8T+1.3T+0.23T+T+1.3T+0.04T+T+1.3T+0.03T=7T.

(14) At the fourth station St4, printing of the yellow image is finished. The elapsed time is [U1+S+Δt2+U2+S+Δt3+U3+S+Δt4+U4] with the addition of the printing time U4 at the fourth station St4. Here, as described above, at the fourth station St4, printing is started from the first printing start position. Therefore, the printing time U4 at the first station St1 is U4=0.8T. Therefore, the elapsed time is U1+S+Δt2+U2+S+Δt3+U3+S+Δt4+U4=0.8T+1.3T+0.23T+T+1.3T+0.04T+T+1.3T+0.03T+0.8T=7.8T.

As described above, even in a case where an image is printed only on a partial region in the circumferential direction of the substrate, the image can be printed efficiently.

Modification Example of Position where Front End of Image is Printed

A position where the front end of an image is printed on the outer circumferential surface of the substrate will be referred to as a front end printing position (the position indicated by the mark M0 in FIG. 8). In a case where a front end printing position is not particularly defined, any position on the outer circumferential surface of the substrate may be set as the front end printing position. In this case, at a time point at which the substrate 2 arrives at the first station St1, it is preferable to set a position located at the printing position to the front end printing position. Consequently, printing can be started at the first station St1 without waiting time. In this case, a plurality of printing start positions are set with the set front end printing position as a reference. For example, in the example of the above embodiment, the first printing start position is set to the set front end printing position, and the second printing start position is set to a position rotated by 0.5 from the first printing start position. For example, in the modification example in which printing start positions are set to three locations, the first printing start position is set to the set front end printing position, the second printing start position is set to a position rotated by 0.33 rotated from the first printing start position, and the third printing start position is set to a position rotated by 0.33 from the second printing start position.

In addition, a position located at the printing position after a predetermined time has elapsed from when the substrate 2 arrives at the first station St1 may be set as the front end printing position. That is, printing may be started after waiting for the elapse of a predetermined waiting time.

Setting Number and Setting Interval of Stations

In the above embodiment, the case where four stations are set on the path of the substrate has been described as an example, but the number of stations set on the path of the substrate is not limited to this. The number of stations may be set as appropriate according to, for example, the purpose and use of printing. For example, five stations may be set, and the respective stations may print white, black, cyan, magenta, and yellow images.

It is not necessary to use all of the set stations. In this case, the substrate passes through a station that is not used without being stopped. In the above embodiment, in a case where printing is performed by using only black and magenta, the substrate passes through the second station and the fourth station without being stopped.

In the above embodiment, the stations are set at equal intervals, but the stations do not necessarily have to be set at equal intervals. In this case, it is preferable to set a printing start position in consideration of setting intervals of the respective stations.

Printing Time at Each Station

In the above embodiment, the substrate 2 is rotated once at each station to complete printing, but the substrate 2 may be rotated a plurality of times to complete printing at one station. In this case, for example, in a case where the substrate 2 is rotated m times to complete printing, the printing time is m×T (here, T is the time for one rotation of the substrate).

### Second Embodiment

In the present embodiment, a case where a rotation speed of a substrate can be selected that printing is performed will be described.

By using a configuration in which a rotation speed of the substrate can be selected, printing according to the purpose and application becomes possible. For example, by increasing a rotation speed of the substrate, high speed printing can be performed. On the other hand, by reducing a rotation speed of the substrate, it is possible to print a higher quality image.

In the following description, a case where a rotation speed of the substrate can be switched between two stages of high speed and low speed will be described. That is, a case where either a first rotation speed or a second rotation speed that is a rotation speed lower than the first rotation speed can be selected will be described. A mode of performing printing at the first rotation speed is set to a high speed mode, and a mode of performing printing at the second rotation speed is set to a low speed mode. In the low speed mode, a higher quality image can be printed. Therefore, the low speed mode is synonymous with a high quality mode.

A fundamental configuration of the apparatus is the same as that in the first embodiment except that a rotation speed of the substrate can be selected. Therefore, here, only differences from the printer of the first embodiment will be described.

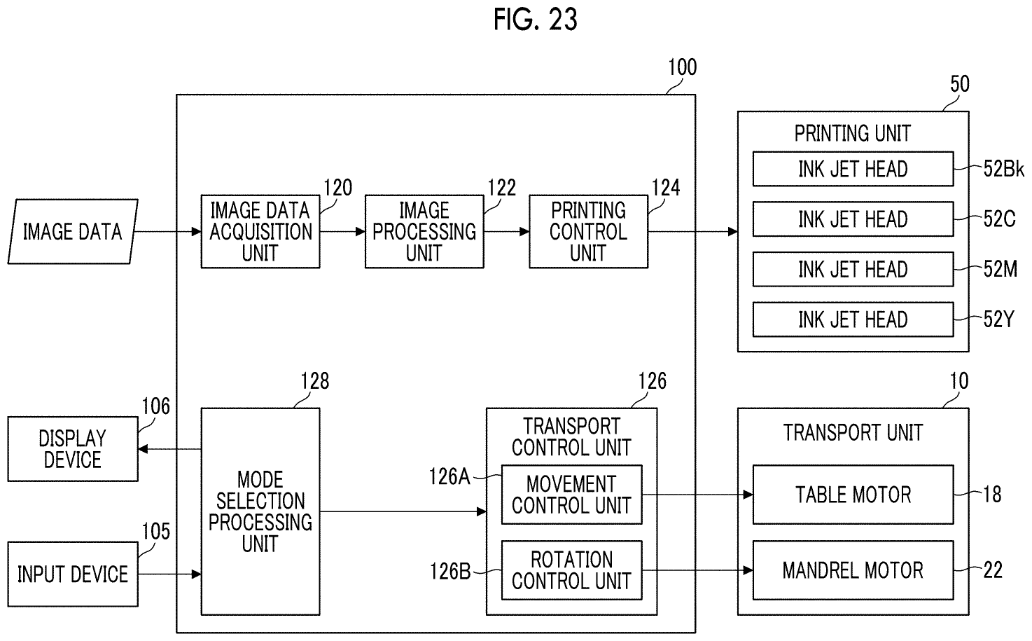

FIG. 23 is a block diagram showing main functions realized by the control unit.

The control unit 100 further has a function of a mode selection processing unit 128. This function is realized by the CPU 101 executing a predetermined program.

The mode selection processing unit 128 performs a process for receiving selection of a printing mode. That is, the mode selection processing unit 128 performs the process of receiving the selection between the high speed mode in which the substrate 2 is rotated at the first rotation speed such that printing is performed and the low speed mode in which the substrate 2 is rotated at the second rotation speed such that printing is performed.

The mode selection processing unit 128 displays a printing mode selection screen in response to an instruction from a user on the display device 106. On the printing mode selection screen, for example, selectable printing modes are listed. In the present embodiment, the high speed mode and the low speed mode are displayed. The mode selection processing unit 128 receives selection of the printing mode via the input device 105. In the present embodiment, the mode selection processing unit 128, the display device 106, and the input device 105 configure selection means. In the present embodiment, a rotation speed of the substrate 2 is changed according to the printing mode. Therefore, selecting the printing mode is synonymous with selecting a rotation speed of the substrate 2.

The transport control unit 126 controls transport of the substrate 2 according to the printing mode selected by the mode selection processing unit 128. That is, the substrate 2 is rotated at a rotation speed and the substrate 2 is transported according to the selected printing mode. A rotation speed of the substrate 2 in a case where the high speed mode is set is denoted by VH, and the time for one rotation of the substrate 2 in a case where the substrate 2 is rotated at the rotation speed VH is denoted by TH. A rotation speed of the substrate 2 in a case where the low speed mode is set is denoted by VL, and the time for one rotation of the substrate 2 in a case where the substrate 2 is rotated at the rotation speed VL is denoted by TL. In the present embodiment, TH=T. TL=1.2T.

The printing control unit 124 controls printing on the substrate 2 according to the printing mode selected by the mode selection processing unit 128.

Printing Process

Printing Process in High Speed Mode

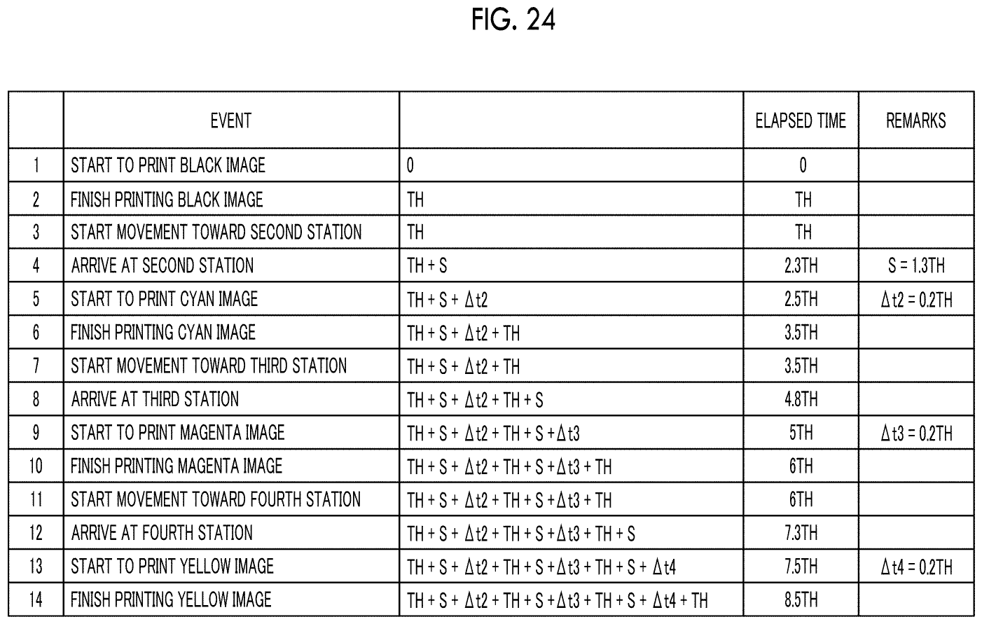

FIG. 24 is a table showing a flow and elapsed time of a series of printing processes in a case where the high speed mode is selected.

As described above, in the high speed mode, the substrate 2 is rotated at the rotation speed VH and makes one rotation for the time TH. TH=T.

The time for the substrate 2 to be moved between the stations is denoted by S, and S=1.3T. Therefore, in the high speed mode, S=1.3TH.

In the present embodiment, an image is printed on the entire circumference of the substrate 2. Therefore, the printing time at each of the stations St1 to St4 is TH.

In the present embodiment, it is assumed that printing start positions are set at two locations on the outer periphery of the substrate 2. That is, it is assumed that a first printing start position and a second printing start position are set. As shown in FIG. 8, the first printing start position indicated by the mark M1 is set to the same position as a position where the front end of an image is printed. On the other hand, the second printing start position indicated by the mark M2 is set to a position rotated by 0.5 from the first printing start position (a point of 50% in the rotation direction of the substrate from the front end of the image).

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [TH] with the addition of the printing time.

(3) The substrate 2 starts to be moved toward the second station St2. Since the movement is started at the same time as printing is finished, the elapsed time is [TH].

(4) The substrate 2 arrives at the second station St2. The elapsed time is [TH+S] with the addition of the transport time S. Since S=1.3TH, TH+S=TH+1.3TH=2.3TH.

(5) Printing of the cyan image is started at the second station St2. The time (waiting time) from when the substrate 2 arrives at the second station St2 to when printing of the cyan image is started is denoted by Δt2. The elapsed time is [TH+S+Δt2] with the addition of the waiting time Δt2.

Here, at a time point at which the substrate 2 arrives at the second station St2, the position rotated by 0.3 from the first printing start position is located at the printing position. A printing start position closest to the printing position at the time point at which the substrate 2 arrives at the second station St2 is the second printing start position. The second printing start position is set to a position rotated by 0.5 from the first printing start position. Therefore, the waiting time Δt2 is 0.2 TH. Therefore, the elapsed time in this mode is TH+S+Δt2=TH+1.3TH+0.2TH=2.5TH.

(6) At the second station St2, printing of the cyan image is finished. The elapsed time is [TH+S+Δt2+TH] with the addition of the printing time TH at the second station St2. Therefore, the elapsed time in this mode is TH+S+Δt2+TH=TH+1.3TH+0.2TH+TH=3.5TH.

(7) The substrate 2 starts to be moved toward the third station St3. Since the movement is started at the same time as printing is finished, the elapsed time is the same as when printing is finished and is [TH+S+Δt2+TH]. Therefore, the elapsed time in this mode is TH+S+Δt2+TH=TH+1.3TH+0.2TH+TH=3.5TH.

(8) The substrate 2 arrives at the third station St3. The elapsed time is [TH+S+Δt2+TH+S] with the addition of the transport time S. Therefore, the elapsed time in this mode is TH+S+Δt2+TH+S=TH+1.3TH+0.2TH+TH+1.3TH=4.8TH.

(9) Printing of the magenta image is started at the third station St3. The time (waiting time) from when the substrate 2 arrives at the third station St3 to when printing of the cyan image is started is denoted by Δt3. The elapsed time is [TH+S+Δt2+TH+S+Δt3] with the addition of the waiting time Δt3.

Here, at a time point at which the substrate 2 arrives at the third station St3, a position rotated by 0.3 from the second printing start position is located at the printing position. At a time point at which the substrate 2 arrives at the third station St3, a printing start position closest to the printing position is the first printing start position. The first printing start position is set to a position rotated by 0.5 from the second printing start position. Therefore, the waiting time Δt3 is 0.2TH. Therefore, the elapsed time in this mode is TH+S+Δt2+TH+S+Δt3=TH+1.3TH+0.2TH+TH+1.3TH+0.2TH=5TH.

(10) At the third station St3, printing of the magenta image is finished. The elapsed time is [TH+S+Δt2+TH+S+Δt3+TH] with the addition of the printing time TH at the third station St3. Therefore, the elapsed time in this mode is TH+S+Δt2+TH+S+Δt3+TH=TH+1.3TH+0.2TH+TH+1.3TH+0.2TH+TH=6TH.

(11) The substrate 2 starts to be moved toward the fourth station St4. Since the movement is started at the same time as printing is finished, the elapsed time is [TH+S+Δt2+TH+S+Δt3+TH], which is the same as when printing is finished. Therefore, the elapsed time in this mode is TH+S+Δt2+TH+S+Δt3+TH=TH+1.3TH+0.2TH+TH+1.3TH+0.2TH+TH=6TH.

(12) The substrate 2 arrives at the fourth station St4. The elapsed time is [TH+S+Δt2+TH+S+Δt3+TH+S] with the addition of the transport time S. Therefore, the elapsed time in this mode is TH+S+Δt2+TH+S+Δt3+TH+S=TH+1.3TH+0.2TH+TH+1.3TH+0.2TH+TH+1.3TH=7.3TH.

(13) Printing of the yellow image is started at the fourth station St4. The time (waiting time) from when the substrate 2 arrives at the fourth station St4 to when printing the yellow image is started is denoted by Δt4. The elapsed time is [TH+S+Δt2+TH+S+Δt3+TH+S+Δt4] with the addition of the waiting time Δt4.

Here, at a time point at which the substrate 2 arrives at the fourth station St4, a position rotated by 0.3 from the first printing start position is located at the printing position. A printing start position closest to the printing position at the time point at which the substrate 2 arrives at the fourth station St4 is the second printing start position. The second printing start position is set to a position rotated by 0.5 from the first printing start position. Therefore, the waiting time Δt4 is 0.2 TH. Therefore, the elapsed time in this example is TH+S+Δt2+TH+S+Δt3+TH+S+Δt4=TH+1.3TH+0.2TH+TH+1.3TH+0.2TH+TH+1.3TH+0.2TH=7.5TH.

(14) At the fourth station St4, printing of the yellow image is finished. The elapsed time is [TH+S+Δt2+TH+S+Δt3+TH+S+Δt4+TH] with the addition of the printing time TH at the fourth station St4. Therefore, the elapsed time in this mode is TH+S+Δt2+TH+S+Δt3+TH+S+Δt4+TH=TH+1.3TH+0.2TH+TH+1.3TH+0.2TH+TH+1.3TH+0.2TH+TH=8.5TH.

Printing Process in Low Speed Mode

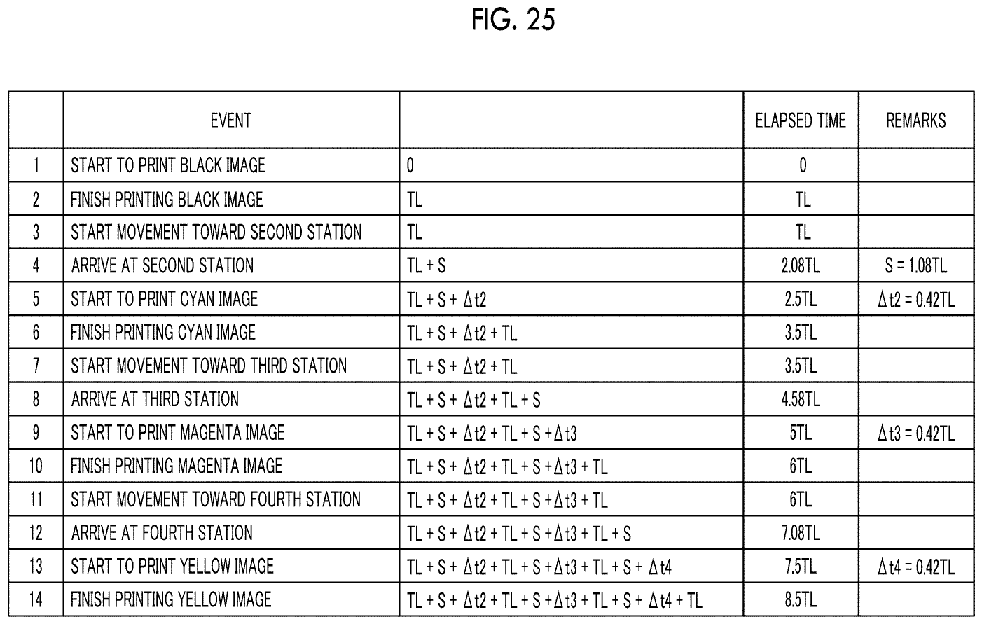

FIG. 25 is a table showing a flow and elapsed time of a series of printing processes in a case where the low speed mode is selected.

As described above, in the low speed mode, the substrate 2 is rotated at the rotation speed VL and is rotated once over the time TL. TL=1.2T.

The time for the substrate 2 to be moved between the stations is denoted by S, and S=1.3T. Therefore, in the low speed mode, S=1.3×(TL/1.2)=1.08TL.

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [TL] with the addition of the printing time.

(3) The substrate 2 starts to be moved toward the second station St2. Since the movement is started at the same time as printing is finished, the elapsed time is [TL].

(4) The substrate 2 arrives at the second station St2. The elapsed time is [TL+S] with the addition of the transport time S. Since S=1.08TL, TL+S=TL+1.08TL=2.08TL.

(5) Printing of the cyan image is started at the second station St2. The time (waiting time) from when the substrate 2 arrives at the second station St2 to when printing of the cyan image is started is denoted by Δt2. The elapsed time is [TL+S+Δt2] with the addition of the waiting time Δt2.

Here, at a time point at which the substrate 2 arrives at the second station St2, a position rotated by 0.08 from the first printing start position is located at the printing position. A printing start position closest to the printing position at the time point at which the substrate 2 arrives at the second station St2 is the second printing start position. The second printing start position is set to a position rotated by 0.5 from the first printing start position. Therefore, the waiting time Δt2 is 0.42TL. Therefore, the elapsed time in this mode is TL+S+Δt2=TL+1.08TL+0.42TL=2.5TL.

(6) At the second station St2, printing of the cyan image is finished. The elapsed time is [TL+S+Δt2+TL] with the addition of the printing time TL at the second station St2. Therefore, the elapsed time in this mode is TL+S+Δt2+TL=TL+1.08TL+0.42TL+TL=3.5TL.

(7) The substrate 2 starts to be moved toward the third station St3. Since the movement is started at the same time as printing is finished, the elapsed time is [TL+S+Δt2+TL], which is the same as when printing is finished. Therefore, the elapsed time in this mode is TL+S+Δt2+TL=TL+1.08TL+0.42TL+TL=3.5TL.

(8) The substrate 2 arrives at the third station St3. The elapsed time is [TL+S+Δt2+TL+S] with the addition of the transport time S. Therefore, the elapsed time in this mode is TL+S+Δt2+TL+S=TL+1.08TL+0.42TL+TL+1.08TL=4.58TL.

(9) Printing of the magenta image is started at the third station St3. The time (waiting time) from when the substrate 2 arrives at the third station St3 to when printing of the cyan image is started is denoted by Δt3. The elapsed time is [TL+S+Δt2+TL+S+Δt3] with the addition of the waiting time Δt3.

Here, at a time point at which the substrate 2 arrives at the third station St3, a position rotated by 0.3 from the second printing start position is located at the printing position. At a time point at which the substrate 2 arrives at the third station St3, a printing start position closest to the printing position is the first printing start position. The first printing start position is set to a position rotated by 0.5 from the second printing start position. Therefore, the waiting time Δt3 is 0.42TL. Therefore, the elapsed time in this mode is TL+S+Δt2+TL+S+Δt3=TL+1.08TL+0.42TL+TL+1.08TL+0.42TL=STL.

(10) At the third station St3, printing of the magenta image is finished. The elapsed time is [TL+S+Δt2+TL+S+Δt3+TL] with the addition of the printing time TL at the third station St3. Therefore, the elapsed time in this mode is TL+S+Δt2+TL+S+Δt3+TL=TL+1.08TL+0.42TL+TL+1.08TL+0.42TL+TL=6TL.

(11) The substrate 2 starts to be moved toward the fourth station St4. Since the movement is started at the same time as printing is finished, the elapsed time is [TL+S+Δt2+TL+S+Δt3+TL], which is the same as when printing is finished. Therefore, the elapsed time in this mode is TL+S+Δt2+TL+S+Δt3+TL=TL+1.08TL+0.42TL+TL+1.08TL+0.42TL+TL=6TL.

(12) The substrate 2 arrives at the fourth station St4. The elapsed time is [TL+S+Δt2+TL+S+Δt3+TL+S] with the addition of the transport time S. Therefore, the elapsed time in this mode is TL+S+Δt2+TL+S+Δt3+TL+S=TL+1.08TL+0.42TL+TL+1.08TL+0.42TL+TL+1.08TL=7.08TL.

(13) Printing of the yellow image is started at the fourth station St4. The time (waiting time) from when the substrate 2 arrives at the fourth station St4 to when printing the yellow image is started is denoted by Δt4. The elapsed time is [TL+S+Δt2+TL+S+Δt3+TL+S+Δt4] with the addition of the waiting time Δt4.

Here, at a time point at which the substrate 2 arrives at the fourth station St4, a position rotated by 0.3 from the first printing start position is located at the printing position. A printing start position closest to the printing position at the time point at which the substrate 2 arrives at the fourth station St4 is the second printing start position. The second printing start position is set to a position rotated by 0.5 from the first printing start position. Therefore, the waiting time Δt4 is 0.42TL. Therefore, the elapsed time in this example is TL+S+Δt2+TL+S+Δt3+TL+S+Δt4=TL+1.08TL+0.42TL+TL+1.08TL+0.42TL+TL+1.08TL+0.42TL=7.5TL.

(14) At the fourth station St4, printing of the yellow image is finished. The elapsed time is [TL+S+Δt2+TL+S+Δt3+TL+S+Δt4+TL] with the addition of the printing time TL at the fourth station St4. Therefore, the elapsed time in this mode is TL+S+Δt2+TL+S+Δt3+TL+S+Δt4+TL=TL+1.08TL+0.42TL+TL+1.08TL+0.42TL+TL+1.08TL+0.42TL+TL=8.5TL.

As described above, even in a case where printing is performed by switching between rotation speeds of the substrate, an image can be efficiently printed by setting the printing start positions at a plurality of locations and performing printing.

### Modification Example

In a case where a rotation speed of the substrate can be selected, it is preferable to set a printing start position according to the selected rotation speed.

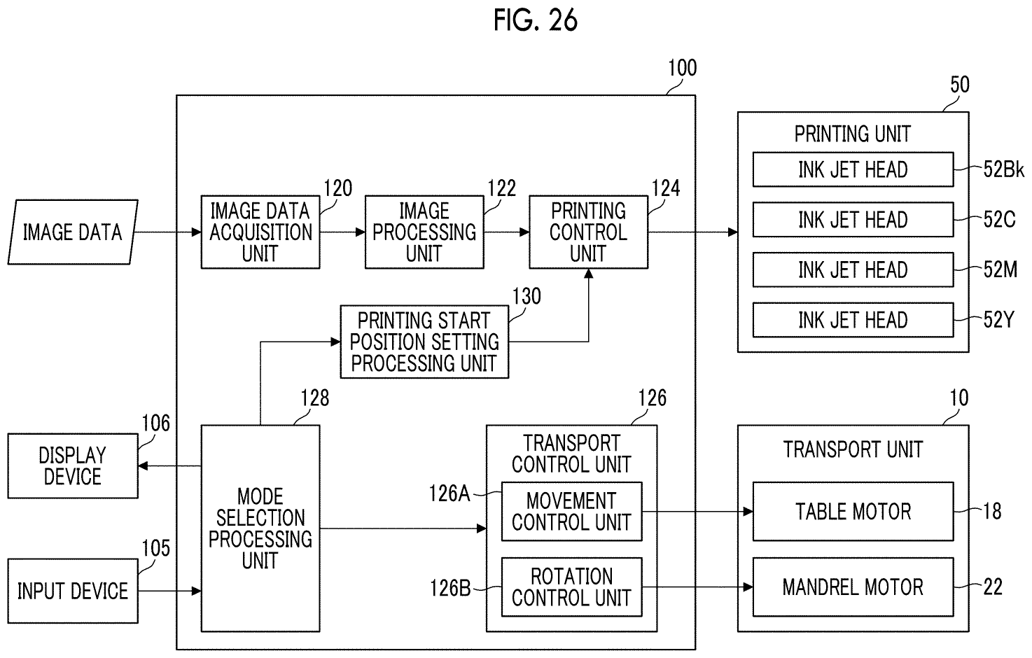

FIG. 26 is a block diagram showing main functions realized by the control unit in a case where a printing start position is set according to a selected rotation speed.

The control unit 100 further has a function of a printing start position setting processing unit 130. This function is realized by the CPU 101 executing a predetermined program.

The printing start position setting processing unit 130 sets a printing start position on the outer circumferential surface of the substrate 2 according to a printing mode selected by the mode selection processing unit 128. The number and positions of printing start positions to be set are predefined according to the printing mode. Information regarding the number and positions of printing start positions to be set (printing start position setting information) is stored in, for example, the ROM 103 or the auxiliary storage device 104. The printing start position setting processing unit 130 reads setting information corresponding to a printing mode selected by the mode selection processing unit 128, and sets a printing start position. In the present embodiment, a printing start position is set as follows in each printing mode.

In the high speed mode, printing start positions are set to two locations on the outer circumferential surface of the substrate 2. That is, the first printing start position and the second printing start position are set. As shown in FIG. 8, the first printing start position is set to the same position as a position where the front end of the image is printed. On the other hand, the second printing start position is set to a position rotated by 0.5 from the first printing start position (a point of 50% in the rotation direction of the substrate from the front end of the image).

In the low speed mode, printing start positions are set to three locations on the outer circumferential surface of the substrate 2. That is, the first printing start position, the second printing start position, and the third printing start position are set. As shown in FIG. 21, the first printing start position is set to the same position as the position where the front end of the image is printed. The second printing start position is set to a position rotated by 0.33 from the first printing start position (a point of 33% from the front end of the image in the rotation direction of the substrate). The third printing start position is set to a position rotated by 0.34 from the second printing start position (a point of 67% from the front end of the image in the rotation direction of the substrate).

As described above, in this example, a different number of printing start positions are set in each printing mode.

The transport control unit 126 controls transport of the substrate 2 according to the printing mode selected by the mode selection processing unit 128. That is, the substrate 2 is rotated at a rotation speed and the substrate 2 is transported according to the selected printing mode. A rotation speed of the substrate 2 in a case where the high speed mode is set is denoted by VH, and the time for one rotation of the substrate 2 in a case where the substrate 2 is rotated at the rotation speed VH is denoted by TH. A rotation speed of the substrate 2 in a case where the low speed mode is set is denoted by VL, and the time for one rotation of the substrate 2 in a case where the substrate 2 is rotated at the rotation speed VL is denoted by TL. In the present embodiment, TH=T. TL=1.2T.

The printing control unit 124 controls printing on the substrate 2 according to the printing mode selected by the mode selection processing unit 128 and the printing start positions set by the printing start position setting processing unit 130.

Printing Process

The processing in a case where the high speed mode is selected is the same as that in the above embodiment. Therefore, here, a process in a case where the low speed mode is selected will be described.

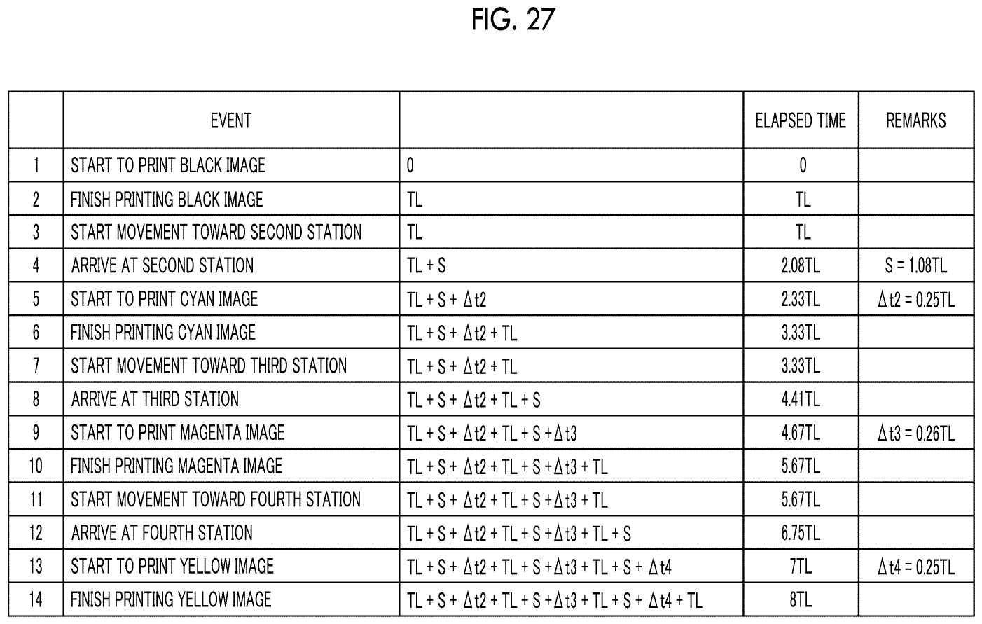

FIG. 27 is a table showing a flow and elapsed time of a series of printing processes in a case where the low speed mode is selected.

As described above, in the low speed mode, the substrate 2 is rotated at the rotation speed VL and is rotated once over the time TL. TL=1.2T.

The time for the substrate 2 to be moved between the stations is denoted by S, and S=1.3T. Therefore, in the low speed mode, S=1.3×(TL/1.2)=1.08TL.

As described above, in the low speed mode, the printing start positions are set to three locations on the outer circumferential surface of the substrate 2. The first printing start position is set to the same position as the position where the front end of the image is printed. The second printing start position is set to a position rotated by 0.33 from the first printing start position (a point of 33% from the front end of the image in the rotation direction of the substrate). The third printing start position is set to a position rotated by 0.34 from the second printing start position (a point of 67% from the front end of the image in the rotation direction of the substrate).

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [TL] with the addition of the printing time.

(3) The substrate 2 starts to be moved toward the second station St2. Since the movement is started at the same time as printing is finished, the elapsed time is [TL].

(4) The substrate 2 arrives at the second station St2. The elapsed time is [TL+S] with the addition of the transport time S. Since S=1.08TL, TL+S=TL+1.08TL=2.08TL.

(5) Printing of the cyan image is started at the second station St2. The time (waiting time) from when the substrate 2 arrives at the second station St2 to when printing of the cyan image is started is denoted by Δt2. The elapsed time is [TL+S+Δt2] with the addition of the waiting time Δt2.

Here, at a time point at which the substrate 2 arrives at the second station St2, a position rotated by 0.08 from the first printing start position is located at the printing position. A printing start position closest to the printing position at the time point at which the substrate 2 arrives at the second station St2 is the second printing start position. The second printing start position is set to a position rotated by 0.33 from the first printing start position. Therefore, the waiting time Δt2 is 0.25TL. Therefore, the elapsed time in this example is TL+S+Δt2=TL+1.08TL+0.25TL=2.33TL.

(6) At the second station St2, printing of the cyan image is finished. The elapsed time is [TL+S+Δt2+TL] with the addition of the printing time TL at the second station St2. Therefore, the elapsed time in this example is TL+S+Δt2+TL=TL+1.08TL+0.25TL+TL=3.33TL.

(7) The substrate 2 starts to be moved toward the third station St3. Since the movement is started at the same time as printing is finished, the elapsed time is [TL+S+Δt2+TL], which is the same as when printing is finished. Therefore, the elapsed time in this example is TL+S+Δt2+TL=TL+1.08TL+0.25TL+TL=3.33TL.

(8) The substrate 2 arrives at the third station St3. The elapsed time is [TL+S+Δt2+TL+S] with the addition of the transport time S. Therefore, the elapsed time in this example is TL+S+Δt2+TL+S=TL+1.08TL+0.25TL+TL+1.08TL=4.41TL.

(9) Printing of the magenta image is started at the third station St3. The time (waiting time) from when the substrate 2 arrives at the third station St3 to when printing of the cyan image is started is denoted by Δt3. The elapsed time is [TL+S+Δt2+TL+S+Δt3] with the addition of the waiting time Δt3.

Here, at a time point at which the substrate 2 arrives at the third station St3, a position rotated by 0.08 from the second printing start position is located at the printing position. A printing start position closest to the printing position at the time point at which the substrate 2 arrives at the third station St3 is the third printing start position. The third printing start position is set to a position rotated by 0.34 from the second printing start position. Therefore, the waiting time Δt3 is 0.26 TL. Therefore, the elapsed time in this example is TL+S+Δt2+TL+S+Δt3=TL+1.08TL+0.25TL+TL+1.08TL+0.26TL=4.67TL.

(10) At the third station St3, printing of the magenta image is finished. The elapsed time is [TL+S+Δt2+TL+S+Δt3+TL] with the addition of the printing time TL at the third station St3. Therefore, the elapsed time in this example is TL+S+Δt2+TL+S+Δt3+TL=TL+1.08TL+0.25TL+TL+1.08TL+0.26TL+TL=5.67TL.

(11) The substrate 2 starts to be moved toward the fourth station St4. Since the movement is started at the same time as printing is finished, the elapsed time is [TL+S+Δt2+TL+S+Δt3+TL], which is the same as when printing is finished. Therefore, the elapsed time in this example is TL+S+Δt2+TL+S+Δt3+TL=TL+1.08TL+0.25TL+TL+1.08TL+0.26TL+TL=5.67TL.

(12) The substrate 2 arrives at the fourth station St4. The elapsed time is [TL+S+Δt2+TL+S+Δt3+TL+S] with the addition of the transport time S. Therefore, the elapsed time in this example is TL+S+Δt2+TL+S+Δt3+TL+S=TL+1.08TL+0.25TL+TL+1.08TL+0.26TL+TL+1.08TL=6.75TL.

(13) Printing of the yellow image is started at the fourth station St4. The time (waiting time) from when the substrate 2 arrives at the fourth station St4 to when printing the yellow image is started is denoted by Δt4. The elapsed time is [TL+S+Δt2+TL+S+Δt3+TL+S+Δt4] with the addition of the waiting time Δt4.

Here, at a time point at which the substrate 2 arrives at the fourth station St4, a position rotated by 0.08 from the first printing start position is located at the printing position. A printing start position closest to the printing position at the time point at which the substrate 2 arrives at the fourth station St4 is the second printing start position. The second printing start position is set to a position rotated by 0.33 from the first printing start position. Therefore, the waiting time Δt4 is 0.25TL. Therefore, the elapsed time in this example is TL+S+Δt2+TL+S+Δt3+TL+S+Δt4=TL+1.08TL+0.25TL+TL+1.08TL+0.26TL+TL+1.08TL+0.25TL=7TL.

(14) At the fourth station St4, printing of the yellow image is finished. The elapsed time is [TL+S+Δt2+TL+S+Δt3+TL+S+Δt4+TL] with the addition of the printing time TL at the fourth station St4. Therefore, the elapsed time in this example is TL+S+Δt2+TL+S+Δt3+TL+S+Δt4+TL=TL+1.08TL+0.25TL+TL+1.08TL+0.26TL+TL+1.08TL+0.25TL+TL=8TL.

Compared with the case where printing start positions are set to two locations, by setting printing start positions to three locations, a total printing time can be reduced by 0.5TL time.

As described above, by setting a printing start position for each printing mode, an image can be printed more efficiently. It is preferable to set the number and positions of printing start positions in consideration of a rotation speed and a transport speed of the substrate, the number and a layout of installed stations, and the like.

### Third Embodiment

In the above embodiments, each station is configured to start printing an image with a predetermined waiting time. In particular, in the control method of the first embodiment, printing of an image is started after the same waiting time at each station after the second station.

Incidentally, a control method of printing an image most efficiently is a control method of printing an image at each station without waiting time.

In the present embodiment, a case where printing of an image is started at each station without waiting time will be described.

In order to start printing an image without waiting time at each station, it is necessary to set a printing start position appropriately. Hereinafter, a method of setting a printing start position for starting image printing without waiting time at each station will be described. An apparatus configuration of the printer is the same as that of the printer of the first embodiment.

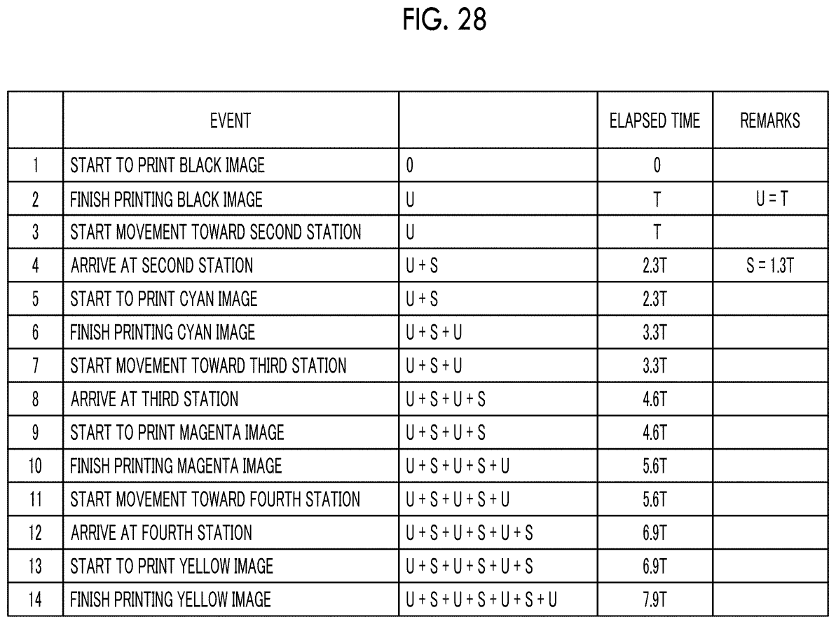

FIG. 28 is a table showing a flow and elapsed time of a series of printing processes in a case where an image is printed at each station without waiting time.

The time for one rotation of the substrate 2 is denoted by T. It is assumed that the time for the substrate 2 to be moved between the stations is denoted by S, and S=1.3T. The printing time at each of the stations St1 to St4 is denoted by U. In the present embodiment, it is assumed that printing of an image is completed in one rotation at each of the stations St1 to St4. Therefore, the printing time U in the present embodiment is T (U=T).

Main events that occur from the start of printing the black image to the completion of printing the yellow image and the elapsed time until the events occur are as follows. The elapsed time is an elapsed time from the start of printing the black image.

(1) Printing of the black image is started at the first station St1. The elapsed time is [0]. It is assumed that printing of the black image is started from the first printing start position.

(2) Printing of the black image is finished at the first station St1. The elapsed time is [U] with the addition of the printing time. As described above, in the present embodiment, U=T.

(3) The substrate 2 starts to be moved toward the second station St2. Since the movement is started at the same time as printing is finished, the elapsed time is [U]. As described above, in the present embodiment, U=T.

(4) The substrate 2 arrives at the second station St2. The elapsed time is [U+S] with the addition of the transport time S. Since S=1.3T, U+S=T+1.3T=2.3T.

(5) Printing of the cyan image is started at the second station St2. As described above, in the present embodiment, printing of the image is started at each station without waiting time. Therefore, the elapsed time is [U+S]. Therefore, the elapsed time in the present embodiment is U+S=T+1.3T=2.3T.

(6) At the second station St2, printing of the cyan image is finished. The elapsed time is [U+S+U] with the addition of the printing time U at the second station St2. Therefore, the elapsed time in the present embodiment is U+S+U=T+1.3T+T=3.3T.

(7) The substrate 2 starts to be moved toward the third station St3. Since the movement is started at the same time as printing is finished, the elapsed time is [U+S+U], which is the same as when printing is finished. Therefore, the elapsed time in the present embodiment is U+S+U=T+1.3T+T=3.3T.

(8) The substrate 2 arrives at the third station St3. The elapsed time is [U+S+Δt2+U+S] with the addition of the transport time S. Therefore, the elapsed time in the present embodiment is U+S+U+S=T+1.3T+T+1.3T=4.3T.

(9) Printing of the magenta image is started at the third station St3. Since the waiting time is 0, the elapsed time is [U+S+Δt2+U+S+Δt3]. Therefore, the elapsed time in the present embodiment is U+S+U+S+=T+1.3T+T+1.3T=4.6T.

(10) At the third station St3, printing of the magenta image is finished. The elapsed time is [U+S+U+S+U] with the addition of the printing time U at the third station St3. Therefore, the elapsed time in the present embodiment is U+S+U+S+U=T+1.3T+T+1.3T+T=5.6T.

(11) The substrate 2 starts to be moved toward the fourth station St4. Since the movement is started at the same time as printing is finished, the elapsed time is [U+S+U+S+U], which is the same as when printing is finished. Therefore, the elapsed time in the present embodiment is U+S+U+S+U=T+1.3T+T+1.3T+T=5.6T.

(12) The substrate 2 arrives at the fourth station St4. The elapsed time is [U+S+U+S+U+S] with the addition of the transport time S. Therefore, the elapsed time in this mode is U+S+U+S+U+S=T+1.3T+T+1.3T+T+1.3T=6.9T.

(13) Printing of the yellow image is started at the fourth station St4. Since the waiting time is 0, the elapsed time is [U+S+U+S+U+S]. The elapsed time in the present embodiment is U+S+U+S+U+S=T+1.3T+T+1.3T+T+1.3T=6.9T.

(14) At the fourth station St4, printing of the yellow image is finished. The elapsed time is [U+S+U+S+U+S+U] with the addition of the printing time U at the fourth station St4. Therefore, the elapsed time in the present embodiment is U+S+U+S+U+S+U=T+1.3T+T+1.3T+T+1.3T+T=7.9T.

From the above description, in order to start printing an image at each station without waiting time, a printing start position may be set such that printing of an image is started at the next timing at each station.

First, a reference position is set. The reference position is a position where printing is started at the first station St1. This position is set as the first printing start position.

In order to start printing an image at the second station St2 without waiting time, it is necessary that the second printing start position is located at the printing position at a time point at which the substrate 2 arrives at the second station St2. For this purpose, the second printing start position may be set to a position rotated by 0.3 from the first printing start position.

In order to start printing an image at the third station St3 without waiting time, it is necessary that the third printing start position is located at the printing position at a time point at which the substrate 2 arrives at the third station St3. For this purpose, the third printing start position may be set to a position rotated by 0.3 from the second printing start position (a position rotated by 0.6 from the first printing start position).

In order to start printing an image at the fourth station St4 without waiting time, it is necessary that the fourth printing start position is located at the printing position at a time point at which the substrate 2 arrives at the fourth station St4. For this purpose, the fourth printing start position may be set to a position rotated by 0.3 from the third printing start position (a position rotated by 0.9 from the first printing start position).

Therefore, in order to start printing an image without waiting time at each station, printing start positions may be set to four locations on the outer circumferential surface of the substrate 2, that is, the position rotated by 0, the position rotated by 0.3, the position rotated by 0.6, and the position rotated by 0.9 with respect to the reference position may be set. As described above, assuming that the reference position is the first printing start position, the second printing start position is set to a position rotated by 0.3 from the first printing start position. The third printing start position is set to a position rotated by 0.6 from the first printing start position. The fourth printing start position is set to a position rotated by 0.9 from the first printing start position.

Assuming that the first printing start position is a position where the front end of an image is printed, the second printing start position is set to a point of 30% in the circumferential direction of the substrate 2 from the front end of the image. The third printing start position is set at a point 60% from the front end of the image in the circumferential direction of the substrate 2. The fourth printing start position is set at a point of 90% from the front end of the image in the circumferential direction of the substrate 2.

In a case of being expressed in a general formula, the printing start position is set as follows.

A total number of stations set on the transport path of the substrate is denoted by n. The stations will be respectively referred to as a first station St1, a second station St2, . . . , and an n-th station Stn in order from the upstream side in the transport direction of the substrate. The image printing time at each of the stations St1, St2, . . . , and Stn is denoted by U. Therefore, for example, in a case where printing is completed in m rotations, U=m×T. Assuming that the stations are disposed at equal intervals, the transport time of the substrate transported between the stations is denoted by S. A value obtained by discarding fractions below the decimal point in <S/U> obtained by dividing S by U is used as (S/U). In this case, for example, in a case where S/U=1.3, a value of <S/U> is <S/U>=<1.3>=1.

Under the above conditions, the number of printing start positions to be set is n. A printing start position at the first station St1 is the first printing start position, a printing start position at the second station St2 is the second printing start position, . . . , and the printing start position at the n-th station Stn is the n-th printing start position.

In a case where i=1, 2, . . . , and n, and a position where the front end of an image is printed on the outer circumferential surface of the substrate is used as a reference, a printing start position at the i-th station is set to a position at a proportion of (i−1)×(S/U−<S/U>) with respect to the entire circumference of the substrate.

For example, in the case of the above embodiment, since U=T and S=1.3T, S/U=1.3T/T=1.3. The value of <S/U> is <S/U>=<1.3>=1.

At the first station St1, (i−1)×(S/U−<S/U>)=(1−1)×(1.3−1)=0 due to i=1. That is, a printing start position is set to the reference position (a position where the front end of the image is printed). This position is set as the first printing start position.

At the second station St2, (i−1)×(S/U−<S/U>)=(2−1)×(1.3−1)=0.3 due to i=2. That is, a printing start position is set to a position rotated by 0.3 from the first printing start position used as a reference (a position at a proportion of 0.3 in a case where the entire circumference is 1). This position is set as the second printing start position.

At the third station St3, (i−1)×(S/U−<S/U>)=(3−1)×(1.3−1)=0.6 due to i=3. That is, a printing start position is set to a position rotated by 0.6 from the first printing start position used as a reference (a position at a proportion of 0.6 in a case where the entire circumference is 1). This position is set as the third printing start position.

At the fourth station St4, (i−1)×(S/U−<S/U>)=(4−1)×(1.3−1)=0.9 due to i=4. That is, a printing start position is set to a position 0.9 rotations from the first printing start position (a position at a proportion of 0.9 in a case where the entire circumference is 1). This position is set as the fourth printing start position.

The printing start position is also a timing for giving a trigger to start printing to the ink jet head. Assuming that a timing of giving a trigger to the ink jet head at the i-station is Ti, Ti may be, in other words, set as a timing at a proportion of Ti/T=(i−1)×(S/U−<S/U>) with respect to the time T for one rotation of the substrate 2.

As described above, according to the printer of the present embodiment, printing of an image can be started at each station without waiting time. Consequently, it is possible to print an image more efficiently.

### Modification Example

Each station does not necessarily have to be disposed at constant intervals. An image does not necessarily have to be printed on the entire circumference of the substrate. In a case where a disposition interval of each station is not constant, and in a case where an image is printed only on a partial region of the outer circumference of the substrate, conditions for starting image printing at each station without waiting time are as follows.

The number of stations set on the transport path of the substrate is denoted by n. The stations will be respectively referred to as a first station, a second station, . . . , and an n-th station in order from the upstream side in the transport direction of the substrate. The time for one rotation of the substrate is denoted by T. In addition, i is 1, 2, . . . , and n, and the transport time of the substrate transported from the i-th station to the (i+1)-th station is denoted by Si. The printing time at the i-station is denoted by Ui. The printing time Ui at the i-th station is synonymous with the time from the start of printing at the i-station to the start of movement of the substrate toward the next station. A value obtained by discarding fractions below the decimal point in the following equation F(i) is defined as <F(i)>.

$$F ( i ) = \frac{{\sum }_{{j = 1}^{}}^{i - 1} ( Uj + Sj )}{T}$$

Under the above conditions, the number of printing start positions to be set is n. A printing start position at the first station St′ is the first printing start position, a printing start position at the second station St2 is the second printing start position, . . . , and the printing start position at the n-th station Stn is the n-th printing start position.

In a case where a position where the front end of an image is printed on the outer circumferential surface of the substrate is used as a reference, a printing start position (first printing start position) at the first station is set to the reference position. That is, a printing start position is set to the position where the front end of the image is printed. This position is a position at a proportion of 0 with respect to the entire circumference of the substrate. On the other hand, a printing start position at the second and subsequent stations, that is, the i-th station after the second station is set to a position of F(i)−<F(i)> with respect to the entire circumference of the substrate.

In a case where an image is printed only on a partial region of the outer periphery of the substrate, and a printing start position is set in a region other than a region where the image is printed, printing is started from the position where the front end of the image is printed, that is, the first printing start position. In this case, idling and waiting are performed until the first printing start position arrives.

### Other Embodiments

Transport Unit

A specific configuration of the transport unit is not particularly limited as long as the transport unit can transport a substrate along the path while rotating the substrate.

Printing Unit

A specific configuration of the printing unit is not particularly limited as long as the printing unit can print an image on an outer circumferential surface of a substrate located at a printing position.

Control Unit

The function of the control unit is realized by various processors. The various processors include a CPU and/or a graphic processing unit (GPU) that is a general-purpose processor that executes a program and functions as various processing units, a programmable logic device (PLD) such as a field programmable gate array (FPGA) of which a circuit configuration is changed after being manufactured, a dedicated electric circuit such as an application specific integrated circuit (ASIC) that is a processor having a circuit configuration specially designed to execute a specific process, and the like. The program is synonymous with software.

One processing unit may be configured with one of these various processors, or may be configured with two or more processors of the same type or different types. For example, one processing unit may be configured by a plurality of FPGAs or a combination of a CPU and an FPGA. A plurality of processing units may be configured by one processor. As an example of configuring a plurality of processing units with one processor, first, there is a form in which one processor is configured by a combination of one or more CPUs and software, as typified by a computer used for a client or a server, and this processor functions as a plurality of processing units. Second, as typified by system on chip (SoC), there is a form in which a processor that realizes functions of the entire system including a plurality of processing units with one integrated circuit (IC) chip is used. As described above, the various processing units are configured by using one or more of the above-various processors as a hardware structure.

### EXPLANATION OF REFERENCES

1: printer
2: substrate
10: transport unit
12: base
14: guide rail
16: table
18: table motor
18A: coil unit
18B: magnet base
20 mandrel
22 mandrel motor
24: guide block
26: bracket
50: printing unit
52Bk: ink jet head
52C: ink jet head
52M: ink jet head
52Y: ink jet head
54: nozzle surface
100: control unit
101: CPU
102: RAM
103: ROM
104: auxiliary storage device
105: input device
106: display device
107: communication interface
120: image data acquisition unit
122: image processing unit
124: printing control unit
126: transport control unit
126A: movement control unit
126B: rotation control unit
128: mode selection processing unit
130: printing start position setting processing unit
DBk: black printing data
DC: cyan printing data
DM: magenta printing data
DY: yellow printing data
I: image printed on outer circumferential surface of substrate
IBk: black image
IC: cyan image
IM: magenta image
IY: yellow image
MN: mark indicating position of nozzle
MP: mark indicating position (printing position) where ink droplets are dropped
M0: mark indicating position where front end of image is printed
M1: mark indicating first printing start position
M2: mark indicating second printing start position
M3: mark indicating third printing start position
St1: first station
St2: second station
St3: third station
St4: fourth station

What is claimed is:

1. A printer that prints an image on an outer circumferential surface of a cylindrical recording medium, the printer comprising:
a transport unit that transports the recording medium along a path while rotating the recording medium in a circumferential direction;
a printing unit that is provided at each of a plurality of stations set on the path and prints an image on the outer circumferential surface of the recording medium located at a printing position; and
a processor, wherein
a plurality of printing start positions are set on the outer circumferential surface of the recording medium, and
the processor performs
transport control of the recording medium for the transport unit,
printing control of the recording medium for the printing unit provided in each station,
in the transport control, performs control for the transport unit such that the recording medium is rotated at a constant speed, movement of the recording medium is stopped each time the recording medium arrives at the station, and the movement of the recording medium is restarted after printing at the station is completed, and
in the printing control, performs control for the printing unit of each station such that image printing is started from the printing start position that first reaches the printing position.

2. The printer according to claim 1, further comprising:
a selection unit that selects a rotation speed of the recording medium, wherein
the plurality of printing start positions are set on the outer circumferential surface of the recording medium for each rotation speed selectable by the selection unit, and
the processor rotates the recording medium at the rotation speed selected by the selection unit in the transport control.

3. The printer according to claim 2, wherein
a different number of printing start positions are set on the outer circumferential surface of the recording medium for each rotation speed selectable by the selection unit.

4. The printer according to claim 1, wherein
in a case where a time from when the recording medium arrives at the station to when the image printing is started is set as a waiting time, the printing start position is set to a position where the image printing is started for the preset waiting time at least at second and subsequent stations.

5. The printer according to claim 4, wherein
at least at the second and subsequent stations, the printing start position is set to the position where the image printing is started for the same waiting time.

6. The printer according to claim 4, wherein
at least at the second and subsequent stations, the printing start position is set to the position where the image printing is started for the waiting time of 0.

7. The printer according to claim 1, wherein
the stations are set at constant intervals on the path.

8. A printer that prints an image on an outer circumferential surface of a cylindrical recording medium, the printer comprising:
a transport unit that transports the recording medium along a path while rotating the recording medium in a circumferential direction;
a printing unit that is provided at each of a plurality of stations set at constant intervals on the path and prints an image on the outer circumferential surface of the recording medium located at a printing position, and
a processor, wherein
the processor performs
transport control of the recording medium for the transport unit,
printing control of the recording medium for the printing unit provided in each station,
in the transport control, performs control for the transport unit such that the recording medium is rotated at a constant speed, movement of the recording medium is stopped each time the recording medium arrives at the station, and the movement of the recording medium is restarted after printing at the station is completed,
in the printing control, performs control for the printing unit of each station such that image printing is started from a printing start position set on the outer circumferential surface of the recording medium, and
in a case where a total number of the stations is denoted by n, i is 1, 2, . . . , and n, the plurality of stations are a first station, a second station, . . . , and an n-th station in order from an upstream side in a transport direction of the recording medium, a printing time at each station is denoted by U, a transport time of the recording medium transported between the stations is denoted by S, and a value obtained by discarding fractions below a decimal point in S/U is defined as <S/U>, the printing start position at an i-station is set to a position at a proportion of (i−1)×(S/U−<S/U>) with respect to an entire circumference of the substrate on the outer circumferential surface of the recording medium with a position where a front end of the image is printed on the outer circumferential surface of the recording medium as a reference.

9. A printer that prints an image on an outer circumferential surface of a cylindrical recording medium, the printer comprising:
a transport unit that transports the recording medium along a path while rotating the recording medium in a circumferential direction;
a printing unit that is provided at each of a plurality of stations set at constant intervals on the path and prints an image on the outer circumferential surface of the recording medium located at a printing position, and
a processor, wherein
the processor performs
transport control of the recording medium for the transport unit,
printing control of the recording medium for the printing unit provided in each station,
in the transport control, performs control for the transport unit such that the recording medium is rotated at a constant speed, movement of the recording medium is stopped each time the recording medium arrives at the station, and the movement of the recording medium is restarted after printing at the station is completed,
in the printing control, performs control for the printing unit of each station such that image printing is started from a printing start position set on the outer circumferential surface of the recording medium, and
in a case where a total number of the stations is denoted by n, i is 1, 2, . . . , and n, the plurality of stations are a first station, a second station, . . . , and an n-th station in order from an upstream side in a transport direction of the recording medium, a time for one rotation of the recording medium is denoted by T, a transport time of the recording medium transported from an i-th station to an (i+1)-th station is denoted by Si, and a printing time at the i-th station is denoted by Ui, a value obtained by discarding fractions below a decimal point in F(i) is defined as <F(i)> as follows, on the outer circumferential surface of the recording medium, with a position where a front end of the image is printed on the outer circumferential surface of the recording medium as a reference, the printing start position at the first station is set to a position at a proportion of 0 with respect to an entire circumference of the substrate, and the printing start position at the i-station after the second station is set to a position at a proportion of F(i)−<F(i)> with respect to the entire circumference of the substrate.

10. The printer according to claim 1, wherein
the printing unit prints the image according to an ink jet method.

11. The printer according to claim 8, wherein
the printing unit prints the image according to an ink jet method.

12. The printer according to claim 9, wherein
the printing unit prints the image according to an ink jet method.
